(19) United States
(12) Patent Application Publication
(10) Pub. No.: US 2022/0404460 A1
(43) Pub. Date: Dec. 22, 2022

(54) SENSOR CALIBRATION METHOD AND APPARATUS, ELECTRONIC DEVICE, AND STORAGE MEDIUM

(71) Applicant: Shanghai SenseTime Lingang Intelligent Technology Co., Ltd, Shanghai (CN)

(72) Inventors: Yuqian LIU, Shanghai (CN); Shuhan SHEN, Shanghai (CN); Baoyu WANG, Shanghai (CN)

(21) Appl. No.: 17/868,166

(22) Filed: Jul. 19, 2022

Related U.S. Application Data
(63) Continuation of application No. PCT/CN2021/125011, filed on Oct. 20, 2021.

(30) Foreign Application Priority Data
Jun. 18, 2021 (CN) 202110678783.9

(51) Int. Cl. G01S 7/40; G01S 13/86; G06T 7/73

(52) U.S. Cl. CPC G01S 7/40; G01S 13/867; G06T 7/73

(57) ABSTRACT

A sensor calibration method and apparatus, and a storage medium are provided. In the method, multiple scene images and multiple first point clouds of a target scene are acquired by an image sensor and a radar sensor. A second point cloud of the target scene is constructed according to the multiple scene images. A first distance error between the image sensor and radar sensor is determined according to first feature point sets and a second feature point set. A second distance error of the radar sensor is determined according to multiple first feature point sets. A reprojection error of the image sensor is determined according to a first global position of the second feature point set in the global coordinate system and first image positions of pixel points corresponding to the second feature point set in the scene image. The radar sensor and image sensor are calibrated.

### CROSS-REFERENCE TO RELATED APPLICATIONS

This application is a continuation application of International Patent Application No. PCT/CN2021/125011, filed on Oct. 20, 2021, which claims priority to Chinese Patent Application No. 202110678783.9, filed to China National Intellectual Property Administration (CNIPA) on Jun. 18, 2021 and entitled “SENSOR CALIBRATION METHOD AND APPARATUS, ELECTRONIC DEVICE, AND STORAGE MEDIUM”. The contents of International Patent Application No. PCT/CN2021/125011 and Chinese Patent Application No. 202110678783.9 are incorporated herein by reference in their entireties.

### BACKGROUND

Fusion of a laser radar and a camera is widely used in the fields such as three-dimensional (3D) reconstruction in robot vision, autonomous navigation and positioning, unmanned aerial vehicles (UAVs), or the like. A single sensor has limitations, for example, the camera is susceptible to illumination, blurry external environment, and the laser radar has sparse data points, while the fusion of the laser radar and the camera may compensate for their respective defects. In order to fuse information obtained by the laser radar and the camera, it is essential to perform joint calibration between the laser radar and the camera. Mutual transformation relationship between spatial coordinate systems of two sensors is determined by calibration, so that information obtained by different sensors is fused under a unified coordinate system.

### SUMMARY

The disclosure relates to the technical field of computers, and in particular to a sensor calibration method and apparatus, an electronic device, and a storage medium.

According to an aspect of the disclosure, there is provided a sensor calibration method, including the following operations. Multiple scene images and multiple first point clouds of a target scene where the intelligent device is located are acquired respectively by an image sensor and a radar sensor disposed on an intelligent device. A second point cloud of the target scene in a global coordinate system is constructed according to the multiple scene images. A first distance error between the image sensor and the radar sensor is determined according to first feature point sets of the first point clouds and a second feature point set of the second point cloud. A second distance error of the radar sensor is determined according to multiple first feature point sets. A reprojection error of the image sensor is determined according to a first global position of the second feature point set in the global coordinate system and first image positions of pixel points corresponding to the second feature point set in the scene images. The radar sensor and the image sensor are calibrated according to the first distance error, the second distance error and the reprojection error, to obtain a first calibration result of the radar sensor and a second calibration result of the image sensor.

According to an aspect of the disclosure, there is provided a sensor calibration apparatus, including a processor; and a memory configured to store instructions executable by the processor, wherein the processor is configured to call the instructions stored in the memory, to perform operations of: acquiring, by an image sensor and a radar sensor disposed on an intelligent device, a plurality of scene images and a plurality of first point clouds of a target scene where the intelligent device is located, respectively; constructing, according to the plurality of scene images, a second point cloud of the target scene in a global coordinate system; determining, according to first feature point sets of the first point clouds and a second feature point set of the second point cloud, a first distance error between the image sensor and the radar sensor; a second distance error determination module configured to determine, according to a plurality of first feature point sets, a second distance error of the radar sensor; determining a reprojection error of the image sensor according to a first global position of the second feature point set in the global coordinate system and first image positions of pixel points corresponding to the second feature point set in the scene images; and calibrating the radar sensor and the image sensor according to the first distance error, the second distance error and the reprojection error, to obtain a first calibration result of the radar sensor and a second calibration result of the image sensor.

In a possible implementation, the apparatus may further include a first feature extraction module and a second feature extraction module. The first feature extraction module is configured to extract feature points from the multiple first point clouds, respectively, to determine a first feature point set of each of the multiple first point clouds. The second feature extraction module is configured to extract feature points from the second point cloud, to determine the second feature point set of the second point cloud. The first distance error determination module may include a first matching sub-module, a first sub-error determination sub-module and a first distance error determination sub-module. The first matching sub-module is configured to determine, for any one set of the first feature point sets, matched first feature point pairs according to distances between first feature points in the first feature point set and second feature points in the second feature point set, each of the first feature point pairs includes a first feature point and a second feature point. The first sub-error determination sub-module is configured to determine, according to multiple matched first feature point pairs, a first sub-error between the first feature point set and the second feature point set. The first distance error determination sub-module is configured to determine, according to multiple first sub-errors, the first distance error between the image sensor and the radar sensor.

According to an aspect of the disclosure, there is provided an electronic device, including a processor and a memory configured to store instructions executable by the processor. The processor is configured to call the instructions stored in the memory, to perform the above method.

According to an aspect of the disclosure, there is provided a computer-readable storage medium, having stored thereon computer program instructions that implement a sensor calibration method, the method comprising: acquiring, by an image sensor and a radar sensor disposed on an intelligent device, a plurality of scene images and a plurality of first point clouds of a target scene where the intelligent device is located, respectively; constructing, according to the plurality of scene images, a second point cloud of the target scene in a global coordinate system; determining, according to first feature point sets of the first point clouds and a second feature point set of the second point cloud, a first distance error between the image sensor and the radar sensor; determining, according to a plurality of first feature point sets, a second distance error of the radar sensor; determining a reprojection error of the image sensor according to a first global position of the second feature point set in the global coordinate system and first image positions of pixel points corresponding to the second feature point set in the scene images; and calibrating the radar sensor and the image sensor according to the first distance error, the second distance error and the reprojection error, to obtain a first calibration result of the radar sensor and a second calibration result of the image sensor.

It should be understood that the above general descriptions and the following detailed descriptions are merely exemplary and explanatory, and are not intended to limit the disclosure. Other features and aspects of the disclosure will become apparent from the following detailed descriptions of exemplary embodiments with reference to the drawings.

### BRIEF DESCRIPTION OF THE DRAWINGS

Here the drawings are incorporated into the description and form part of the description, and these drawings illustrate embodiments in accordance with the disclosure, and are intended to explain the technical solutions of the disclosure, together with the description.

FIG. 1 shows a flowchart of a sensor calibration method according to an embodiment of the disclosure.

FIG. 2 shows a schematic diagram of a sensor calibration method according to an embodiment of the disclosure.

FIG. 3 shows a block diagram of a sensor calibration apparatus according to an embodiment of the disclosure.

FIG. 4 shows a block diagram of an electronic device according to an embodiment of the disclosure.

FIG. 5 shows a block diagram of an electronic device according to an embodiment of the disclosure.

### DETAILED DESCRIPTION

Various exemplary embodiments, features and aspects of the disclosure will be described in detail below with reference to the drawings. The same reference numerals in the drawings indicate elements with identical or similar functions. Although various aspects of the embodiments are shown in the drawings, the drawings are not necessarily drawn to scale, unless indicated specifically.

The specially used word “exemplary” here means “used as an example, embodiment or illustration”. Any embodiment described as “exemplary” here is not necessary to be construed as superior to or better than other embodiments.

The term “and/or” here is merely an association relationship that describes associated objects, and indicates that there may be three relationships, for example, A and/or B may indicate three situations, that is, only A is present, both A and B are present, and only B is present. Furthermore, the term “at least one of” here indicates any one of multiple items or any combination of at least two of multiple items, for example, the inclusion of at least one of A, B or C may indicate the inclusion of any one or more elements selected from the group composed of A, B and C.

Furthermore, numerous specific details are given in the following detailed description to better explain the disclosure. It should be understood by those skilled in the art that the disclosure may be practiced without certain specific details. In some embodiments, methods, means, elements and circuits well known to those skilled in the art have not been described in detail, so as to highlight the subject matter of the disclosure.

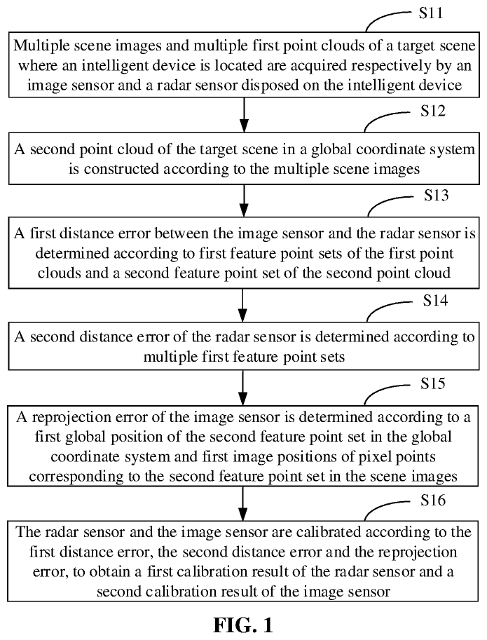

FIG. 1 shows a flowchart of a sensor calibration method according to an embodiment of the disclosure, this sensor method may be performed by an electronic device such as a terminal device, a server, or the like, and the terminal device may be an intelligent device, a user equipment (UE), a mobile device, a user terminal, a terminal, a cellular phone, a cordless phone, a personal digital assistant (PDA), a hand-held device, a computing device, a vehicle onboard device, a wearable device, or the like. The intelligent device may include any one of an intelligent vehicle, an intelligent robot, or an intelligent robot arm. The method may be implemented by a processor in the electronic device calling computer-readable instructions stored in a memory, or, the method may be performed by a server. As shown in FIG. 1, the sensor calibration method includes the following operations.

In operation S11, multiple scene images and multiple first point clouds of a target scene where the intelligent device is located are acquired respectively by an image sensor and a radar sensor disposed on an intelligent device.

As described above, the intelligent device may include any one of an intelligent vehicle, an intelligent robot, or an intelligent robot arm. The image sensor may include at least one of a monocular RGB camera, a binocular RGB camera, a TOF camera, or an infrared camera. The radar sensor includes any one of a laser radar or a millimeter wave radar. The laser radar may include a single-layer laser radar or a multi-layer laser radar, and the image sensor may include one or more image sensors.

It should be understood that the image sensor and the radar sensor may be fixedly disposed on the intelligent device, and the image sensor and the radar sensor fixedly disposed on the intelligent device have a fixed relative position there-between.

The target scene may refer to a scene for calibration, e.g., a crossroad. Objects having rich textures and geometries may be included in the target scene, to facilitate construction of point clouds based on the scene image and registration of the point clouds (i.e., extraction of feature points and matching of feature point pairs). The selection of the target scene is not limited in the embodiment of the disclosure.

It should be understood that the intelligent device may move within the target scene, for example, may move circularly by going around “8”, to acquire multiple scene images and multiple first point clouds of a target scene. The scene image may be data acquired by the image sensor, and the first point cloud may be data acquired by the radar sensor.

In the process of acquiring the scene images and the first point clouds of the target scene, the intelligent device may acquire the scene images and the first point clouds by stopping movement at an interval (for example, stopping the vehicle at an interval), that is, stopping the movement every a movement distance, and triggering the image sensor and the radar sensor at the stop position, to acquire the scene image and the first point cloud once, respectively. Therefore, it may ensure the same spatial pose for different sensors to acquire data at the same time, that is, different sensors have a fixed relative pose there-between, and the accuracy of calculating distance errors between different sensors subsequently may be improved.

Of course, the scene images and the first point clouds may be acquired respectively during continuous movement of the intelligent device, which is not limited in the embodiment of the disclosure.

In operation S12, a second point cloud of the target scene in a global coordinate system is constructed according to the multiple scene images.

The global coordinate system may be understood as a world coordinate system for the target scene, that is, a world coordinate system constructed with the target scene. It should be understood that all of objects (including the intelligent device) in the target scene are located in the global coordinate system.

A known 3D mapping technology, such as a simultaneous localization and mapping (SLAM) technology and a structure from motion (SFM) technology, may be used to implement construction of the second point cloud of the target scene in the global coordinate system according to the multiple scene images, which is not limited in the embodiment of the disclosure.

In operation S13, a first distance error between the image sensor and the radar sensor is determined according to first feature point sets of the first point clouds and a second feature point set of the second point cloud.

The first feature point set of the first point cloud may be understood as a set of feature points in the first point cloud. The second feature point set of the second point cloud may be understood as a set of feature points in the second point cloud.

In a possible implementation, the feature points in the first point cloud and the feature points in the second point cloud may be extracted respectively by using a neural network, to form the first feature point set and the second feature point set respectively. It should be understood that a network structure, a network type, a training mode, or the like of the neural network are not limited in the embodiment of the disclosure.

It should be understood that extraction of the feature points in the first point cloud and the second point cloud is equivalent to extraction of data points, having prominent features, in the first point cloud and the second point cloud. Therefore, when the first distance error is calculated, not only the feature points may be efficiently used for registration of the point clouds, to improve the accuracy of calculating the first distance error, but also the amount of calculation may be reduced, to improve the operation efficiency.

As described above, the first point cloud may include multiple first point clouds, feature points in all or part of the first point clouds may be extracted to obtain a first feature point set of all or part of the first point clouds, and the first feature point set may include one or more first feature point sets. Part of the first point clouds are selected to extract feature points therefrom, which may reduce the operation amount of calculating the first distance error subsequently and improve the operation efficiency.

In a possible implementation, the determining, according to first feature point sets of the first point clouds and the second feature point set of the second point cloud, the first distance error between the image sensor and the radar sensor may include the following operations. Matched first feature point pairs are determined according to global positions of first feature points in the first feature point set under the global coordinate system and global positions of second feature points in the second feature point set under the global coordinate system, each of the first feature point pairs includes a first feature point and a second feature point. The first distance error is determined according to distances between first feature points and second feature points of multiple first feature point pairs.

The first feature point and the second feature point corresponding to a minimum value among the distances between the feature points in the first feature point set and the feature points in the second feature point set may be used as the first feature point pair. It may be understood that any known distance calculation manner, such as Euclidean distance, cosine distance, or the like, may be used to calculate the distances between the feature points, which is not limited in the embodiment of the disclosure.

The determining the first distance error between the image sensor and the radar sensor according to distances between first feature points and second feature points of multiple first feature point pairs may include the following operations. The first distance error is determined according to distances between first feature points and second feature points of multiple first feature point pairs.

It may be understood that when there is one first feature point set, a sum of the distances between first feature points and second feature points of multiple first feature point pairs may be directly used as the first distance error. When there are multiple first feature point sets, a sub-error may be determined for each of the first feature point sets in the above manner, and then a sum of sub-errors corresponding to the multiple first feature point sets is used as the first distance error.

In operation S14, a second distance error of the radar sensor is determined according to multiple first feature point sets.

As described above, the multiple first point clouds are point clouds acquired by the radar sensor at different positions of the target scene. Since the radar sensor may have different radar poses at different positions, there may also be errors between the first point clouds acquired by the radar sensor at different positions.

It may be understood that for the same object in the target scene, data points, indicating the same object in the same coordinate, of the first point clouds acquired at different positions should be coincident or infinitely close. Based on this, the errors between the first point clouds acquired at different positions may be understood as for the same object in the target scene, errors between the data points, indicating the same object, of the first point clouds acquired at different positions.

As described above, the first feature point set of the first point cloud may be understood as a set of feature points in the first point cloud. All or part of the first point clouds may be selected to extract feature points therefrom, to obtain the first feature point set. It should be understood that the multiple first feature point sets may also be understood as at least two first feature point sets.

It may be understood that the first point clouds acquired by the radar sensor are constructed based on a radar coordinate system of the radar sensor itself, that is, coordinates of the first feature points are coordinates in the radar coordinate system. In order to facilitate calculation of the second distance error, the first feature points in each of the first feature point sets may be transformed into the global coordinate system based on a radar pose acquiring each of the first point clouds, that is, multiple first feature point sets are placed in the same coordinate system to calculate the second distance error.

The radar pose when each of the first points is acquired may be determined by a combined inertial navigation system, a global satellite navigation system, and/or an inertial navigation system, or the like installed on the intelligent device, which is not limited in the embodiment of the disclosure.

In a possible implementation, the determining the second distance error of the radar sensor according to the multiple first feature point sets may include the following operations. For any two of the first feature point sets, matched second feature point pairs in any two of the first feature point sets are determined. A distance between two feature points in the second feature point pairs is determined according to coordinates of the two feature points in the global coordinate system. The second distance error is determined according to distances of the multiple second feature point pairs.

Any two of first feature point sets may be two feature point sets, adjacent to each other in the acquisition timing, of multiple first feature point sets, or may be two feature point sets selected at an interval, which is not limited in the embodiment of the disclosure.

It should be understood that when there are two first feature point set, a sum of the distances between multiple second feature point pairs may be directly used as the second distance error. When there are multiple first feature point sets, a sum of the distances between multiple second feature point pairs may be determined as a sub-error, and then a sum of multiple sub-errors is used as the second distance error.

In operation S15, a reprojection error of the image sensor is determined according to a first global position of the second feature point set in the global coordinate system and first image positions of pixel points corresponding to the second feature point set in the scene images.

As described above, the second point cloud constructed based on the multiple scene images is a point cloud in the global coordinate system. The pixel point corresponding to the second feature point set is a pixel point corresponding to a second feature point in the second feature point set. The pixel point corresponding to the second feature point may be understood as a two-dimensional point (2D) corresponding to a 3D point on a space object.

It should be understood that the second feature point is a 3D point in space, and the pixel point corresponding to the second feature point is a 2D point in the scene image. The first image position of the pixel point in the scene image may be understood as a 2D coordinate of the pixel point in an image coordinate system of the image sensor.

In theory, a projection point projected in the scene image by the second feature point in the second feature point set via camera parameters of the image sensor, should coincide with the pixel point corresponding to the second feature point. Since there may be an error between camera parameters for calculating the projection point and actual camera parameters of the image sensor, and there may also be an error between the second point cloud constructed by the scene image and an actual object position in the target scene, there may be an error between the projection point and the pixel point, that is, positions of the projection point and the pixel point do not coincide.

The camera parameters may include internal camera parameters and pose (i.e., external parameters) of the camera, and for example, the camera parameters for calculating the projection point may be historically calibrated camera parameters that may have an error with respect to the actual camera parameters. Therefore, the image sensor may be calibrated by the sensor calibration method according to the embodiment of the disclosure, that is, the camera parameters of the image sensor may be calibrated, so that the calibrated camera parameters are close to the actual camera parameters.

In a possible implementation, the determining the reprojection error of the image sensor according to the first global position of the second feature point set in the global coordinate system and the first image position of the pixel point corresponding to the second feature point set in the scene image may include the following operations. A second image position of a second feature point of the second feature point set in the scene image is determined according to a first global position of the second feature point and camera parameters of the image sensor. A distance between a projection point of the second feature point and a corresponding pixel point is determined according to the second image position and the first image position. The reprojection error is determined according to multiple distances.

As described above, the scene image may include multiple scene images, and all or part of the scene images may be used to calculate the reprojection error. That is, for any one of the scene images, multiple distances corresponding to each of the scene images are calculated in the above manner, and a sum of the multiple distances is used as a reprojection sub-error corresponding to the scene image. Furthermore, a sum of projection sub-errors corresponding to the multiple scene images may be used as the reprojection error of the image sensor.

In operation S16, the radar sensor and the image sensor are calibrated according to the first distance error, the second distance error and the reprojection error, to obtain a first calibration result of the radar sensor and a second calibration result of the image sensor.

It may be understood that the radar sensor and the image sensor are calibrated, that is, the radar pose of the radar sensor and the camera parameters of the image sensor are optimized.

An optimization algorithm known in the art, such as a Bundle Adjustment (BA) algorithm, may be used to optimize the radar pose of the radar sensor and the camera parameters of the image sensor according to the first distance error, the second distance error and the reprojection error, which is not limited in the embodiment of the disclosure. The first calibration result of the radar sensor includes an optimized radar pose, and the second calibration result of the image sensor includes optimized camera parameters.

It is considered that a round of optimization is carried out according to the above sensor calibration method, an optimum radar pose and camera parameters may not be obtained by such optimization. In a possible implementation, the above sensor calibration method may be performed again according to the optimized radar pose and the optimized camera parameters, until an number of iterative rounds is satisfied, or the radar pose and the camera parameters are converged, to obtain the first calibration result of the radar sensor and the second calibration result of the image sensor.

In the embodiment of the disclosure, the radar sensor and the image sensor may be calibrated automatically by using the first distance error between the image sensor and the radar sensor, the second distance error of the radar sensor, and the reprojection error of the image sensor, and an accuracy of the calibration result may be provided by using a combination of the first distance error, the second distance error and the reprojection error. Compared with a manner of calibrating by using a calibration object in the related art, the calibration process does not use the calibration object, has a simple operation, has a small calibration error, and may meet the requirement of regular calibration.

As described above, feature points having prominent features may be extracted from the first point cloud and the second point cloud. In a possible implementation, the method may further include the following operations.

In operation S21, feature points are extracted from the multiple first point clouds respectively, to determine a first feature point set of each of the multiple first point clouds.

In operation S22, feature points are extracted from the second point cloud, to determine the second feature point set of the second point cloud.

It should be understood that operations S21 and S22 may be performed respectively after the first point cloud and the second point cloud are obtained. A sequence of performing operations S21 and S22 is not limited in the embodiment of the disclosure.

In a possible implementation, the operation S21 of extracting feature points from the multiple first point clouds respectively, to determine the first feature point set of each of the multiple first point clouds may include the following operations.

In operation S211, for any one of the first point clouds, a point cloud sequence of the first point cloud is determined according to a relative position of each of laser emission points of the radar sensor.

It should be understood that the radar sensor may include one or more laser emitters. Each of the laser emitters may emit one or more laser beams, and during a polling period, one or more laser emitters emit the laser by polling, and a position of the laser emitter emitting the laser is the laser emission point. The radar sensor emitting a laser beam may be a single-layer laser radar, and the radar sensor emitting multiple laser beams may be a multi-layer laser radar.

Based on this, in order to facilitate subsequent extraction of feature points from each of the first point clouds, each of the first point clouds may be sorted to obtain an ordered first point cloud, i.e., the point cloud sequence of the first point cloud. The relative position between the laser emission points of the radar sensor may be determined, and then data points in the first point cloud are sorted according to the relative position, to obtain an ordered first point cloud, i.e., the point cloud sequence of the first point cloud.

The determining the relative position of each of laser emission points may include the following operations. A vertical angle and a horizontal angle of each of the laser emission points are determined. It should be understood that the vertical angle may represent an emission orientation of each of laser beams emitted by a laser emission point in the vertical direction, and the horizontal angle may represent an emission orientation of each of laser beams emitted by a laser emission point in the horizontal direction.

According to the vertical angle, sorting of each of the laser emission points in the vertical direction may be implemented, that is, sorting of the data points in the first point cloud in the vertical direction may be implemented. According to the horizontal angle, sorting of each laser beam of each of the laser emission points in the horizontal direction may be implemented, that is, sorting of the data points in the horizontal direction may be implemented. After the data points in the first point cloud are sorted in the horizontal direction and the vertical direction, an ordered point cloud sequence may be obtained.

In a possible implementation, the vertical angle of each of the laser emission points may be determined by formula (1), and the horizontal angle thereof may be determined by formula (2):

$${θ}_{1} = arc tan ( \frac{{z}_{1}}{\sqrt{{x}_{l}^{2} + {y}_{l}^{2}}} ) \qquad ( 1 )$$

$${θ}_{2} = arc tan ( \frac{{y}_{l}}{{x}_{l}} ) \qquad ( 2 )$$

here (xₗ, yₗ, zₗ) represents coordinates of the data points in the first point cloud in the radar coordinate system of the radar sensor.

It should be understood that for each of the multiple first point clouds, the point cloud sequence of each of the first point clouds may be determined in a manner of operation S211.

In operation S212, multiple first adjacent points corresponding to any one of first data points in the first point cloud are determined according to the point cloud sequence of the first point cloud.

It should be understood that the point cloud sequence may represent a sequence relationship, i.e., a permutation relationship, between the data points in the first point cloud. Multiple first adjacent points corresponding to any one of first data points in the first point cloud may be determined according to the sequence relationship. The number of the first adjacent points may be determined according to actual requirements, which is not limited in the embodiment of the disclosure.

For example, five adjacent data points arranged at the left and right of a first data point in the horizontal direction, and/or six adjacent data points arranged above and below the first data point in the vertical direction, or the like may be selected as first adjacent points adjacent to the first data point. It should be understood that those skilled in the art may select multiple first adjacent points by setting a selection rule of the first adjacent points according to actual requirements, which is not limited in the embodiment of the disclosure.

In operation S213, a curvature corresponding to the first data point is determined according to a coordinate of the first data point and coordinates of the multiple first adjacent points.

In a possible implementation, the curvature C corresponding to the first data point may be determined by formula (3):

$$C = \frac{1}{‖ {X}_{( k , i )}^{L} ‖} ‖ {\sum }_{j ∉ i} ( {X}_{( k , i )}^{L} - {X}_{( k , {i}_{0} )}^{L} ) ‖ \qquad ( 3 )$$

here k represents the k-th first point cloud of the multiple first point clouds, i represents the i-th first data point in the first point cloud, L represents the radar coordinate system of the radar sensor, X_{(k,i)}^{L} represents a coordinate of the i-th first data point in the k-th first point cloud in the radar coordinate system, j represents the j-th first adjacent point of the multiple first adjacent points, X_{(k,i}_{₀}₎^{L} represents a coordinate of the i₀-th first adjacent point in the k-th first point cloud in the radar coordinate system, and ∥ ∥ represents a norm.

In operation S214, the first feature point set in the first point cloud is determined according to curvature of multiple first data points in the first point cloud.

It should be understood that for each of first data points in any one of the first point clouds, the curvature of each of the first data points may be determined according to operations S212 to S213.

In a possible implementation, the determining, according to curvature of the multiple first data points in the first point cloud, the first feature point set in the first point cloud may include the following operations. Data points in which curvature of the multiple first data points is greater than a first curvature threshold are selected, and/or data points in which curvature of the multiple first data points is smaller than a second curvature threshold are selected, to form the first feature point set.

The first curvature threshold and the second curvature threshold may be determined according to an average value of the curvature of the multiple first data points, historical experience, or the like. For example, two times of the average value of the curvature of the multiple first data points may be used as the first curvature threshold, and half of the average value of the curvature of the multiple first data points may be used as the second curvature threshold, which are not limited in the embodiment of the disclosure.

It may be known that the greater a curvature of a data point, the greater a probability that the data point is an edge point, and the smaller the curvature, the greater a probability that the data point is a plane point. Therefore, a data point having a greater curvature and/or a smaller curvature may be selected as a feature point having a prominent feature, that is, the data point having a greater probability to be the edge point or the plane point. The edge point may be understood as a point on an edge of an object, and the plane point may be understood as a point on a surface of the object.

It should be understood that for each of the multiple first point clouds, the first feature point set of each first point cloud may be determined according to operations S212 to S214.

In the embodiment of the disclosure, the first feature point set of each first point cloud may be obtained efficiently and accurately.

In a possible implementation, the operation S214 of determining, according to curvature of the multiple first data points in the first point cloud, the first feature point set in the first point cloud may include the following operations.

The multiple first data points are sorted according to the curvature of the multiple first data points, to obtain a sorting result. n first data points in the sorting result are selected in a descending order, as n edge points. Or, m first data points in the sorting result are selected in an ascending order, as m plane points. n and m are positive integers, and the first feature point set includes at least the edge points or the plane points.

The sorting the multiple first data points according to the curvature of the multiple first data points may include the following operations. The multiple first data points are sorted in a descending order or an ascending order according to the curvature of the multiple first data points, which is not limited in the embodiment of the disclosure. It should be understood that the sorting result may include an ascending sorting result or a descending sorting result.

As described above, the greater a curvature of a data point, the greater a probability that the data point is an edge point, and the smaller the curvature, the greater a probability that the data point is a plane point. Therefore, n first data points in the sorting result are selected in a descending order, as n edge points. Or, m first data points in the sorting result are selected in an ascending order, as m plane points.

Here n and m may be the same or different, and values of n and m may be determined according to the number of the first data points, operational capability of the processor, or the like. For example, each of n and m may be fixedly set to 100 respectively, or each of n and m may be set to ten percent of the number of the first data points, which is not limited in the embodiment of the disclosure.

For example, the first data points are arranged in a descending order, to obtain an arrangement result of “s1, s2, s3, s4, . . . , s97, s98, s99, s100”. Each of n and m takes a value of ten, then “s1, s2, . . . , s10” may be selected in a descending order, as ten edge points, and “s91, s92, . . . , s100” may be selected in an ascending order, as ten plane points. The first feature point set includes “s1, s2, . . . , s10, s91, s92, . . . , s100”.

In the embodiment of the disclosure, the first feature point set may be determined more flexibly and efficiently according to a magnitude of curvature.

In a possible implementation, the operation S22 of extracting feature points from the second point cloud, to determine the second feature point set of the second point cloud may include the following operations.

In operation S221, for any one of second data points in the second point cloud, multiple second adjacent points corresponding to the second data point are determined from the second point cloud.

It should be understood that the second point cloud constructed according to the multiple scene images may be an ordered second point cloud, that is, a sequence relationship (arrangement relationship) between the second data points in the second point cloud is known. Multiple second adjacent points adjacent to any one of second data points in the second point cloud may be determined according to the sequence relationship. The number of the second adjacent points may be determined according to actual requirements, which is not limited in the embodiment of the disclosure.

For example, ten adjacent data points arranged at the left and right of a second data point in the horizontal direction, and/or ten adjacent data points arranged above and below the second data point in the vertical direction, or the like may be selected as second adjacent points adjacent to the second data point. It should be understood that those skilled in the art may select multiple second adjacent points by setting a selection rule of the second adjacent points according to actual requirements, which is not limited in the embodiment of the disclosure.

In a possible implementation, a KD-tree, also known as a k-dimensional tree, a k-d tree and a k-dimension tree, may be used to store the second point cloud. Therefore, multiple second adjacent points adjacent to each of second data points may be searched conveniently and efficiently in the KD-tree.

In operation S222, a distance between the second data point and each of the second adjacent points is determined respectively, according to a coordinate of the second data point and coordinates of the multiple second adjacent points.

A known distance calculation manner, such as Euclidean distance, cosine distance, or the like, may be used to determine the distance between the second data point and each of the second adjacent points respectively, according to the coordinate of the second data point and coordinates of the multiple second adjacent points, which is not limited in the embodiment of the disclosure.

In operation S223, the second data point is determined as the second feature point in the second feature point set, in response to the distance between the second data point and each of the second adjacent points being smaller than a first distance threshold.

It should be understood that for the distance between each of the second adjacent points and the second data point, a case where a distance between a certain second adjacent point and the second data point is too large does not occur usually. When the case occurs, the second data point may be determined as an invalid point, that is, the second data point is not used as the second feature point in the second feature point set.

The first distance threshold may be determined according to actual requirements, a density of the second point cloud, or the like, and for example, may be set to one meter, which is not limited in the embodiment of the disclosure. The distance between the second data point and each of the second adjacent points is smaller than the first distance threshold, which means that the second data point is a valid data point, and the second data point may be determined as the second feature point in the second feature point set. It should be understood that the second feature point set may include multiple second feature points.

In the embodiment of the disclosure, the second feature point set may be determined according to the distance between the second data point and the second adjacent point corresponding thereto, which is equivalent to filtering and screening the second point cloud to determine a valid second feature point set.

As described above, the second feature point set includes multiple second feature points, the object may include an edge point on an edge of the object and a plane point on a surface of the object. In order to facilitate calculation of the first distance error between the radar sensor and the image sensor subsequently, in a possible implementation, the method may further include the following operation. In operation S224, at least edge points or plane points are determined from the multiple second feature points.

In a possible implementation, the operation S224 of determining at least edge points or plane points from the multiple second feature points may include the following operations.

For any one of the second feature points, a covariance matrix of multiple second adjacent points corresponding to the second feature point is determined, and the covariance matrix is decomposed to obtain a multi-dimensional feature value. The second feature point is determined as the edge point, in response to a difference between any one-dimensional feature value and each-dimensional feature value of the multi-dimensional feature value exceeding a difference threshold. Therefore, the edge point may be determined effectively from the second feature points.

It should be understood that the second feature point belong to the second data points, multiple second adjacent points corresponding to the second feature point are multiple second adjacent points adjacent to the second feature point.

The determining the covariance matrix of multiple second adjacent points corresponding to the second feature point may include the following operation. The covariance matrix A of the multiple second adjacent points is obtained according to a column vector Y of the multiple second adjacent points and a formula (4) for calculating the covariance matrix.

A=E[(Y−E[Y])(Y−E[Y])^{T}] (4)

Here E[Y] represents expectation of the column vector Y, ( )^{T} represents transpose of a matrix.

In a possible implementation, a matrix decomposition algorithm known in the art, such as a singular value decomposition (SVD) algorithm, may be used to implement decomposition of the covariance matrix, to obtain the multi-dimensional feature value. It should be understood that a multi-dimensional feature vector corresponding to the multi-dimensional feature value may also be obtained. The edge point may be determined from the second feature points by using the multi-dimensional feature value in the disclosure.

It may be understood that when any-dimensional feature value of the multi-dimensional feature value is much greater than other-dimensional feature value, the second feature point may be considered to have a prominent edge feature, and the second feature point may be considered to be the edge point. Any-dimensional feature value is much greater than other-dimensional feature value, which means that the difference between any one-dimensional feature value and each-dimensional feature value exceeds the difference threshold.

The difference threshold may be determined according to historical experience, deviation of the difference between any one-dimensional feature value and each-dimensional feature value, variance, or the like, which is not limited in the embodiment of the disclosure.

In a possible implementation, the operation S224 of determining at least edge points or plane points from the multiple second feature points may further include the following operations.

For any one of the second feature points, a plane equation is fitted according to the multiple second adjacent points corresponding to the second feature point, and a normal vector of the plane equation is determined. The second feature point is determined as the plane point, in response to products of the multiple second adjacent points corresponding to the second feature point and the normal vector falling within a threshold range. Therefore, the plane point may be determined effectively from the second feature points.

A plane fitting manner known in the art may be used to fit the plane equation according to coordinates of the multiple second adjacent points, and for example, the plane equation may be expressed as ax+by+cz=0, here a, b, c and d represent parameters of the plane equation, and (a, b, c) may represent a normal vector of the plane equation. It should be understood that after fitting the plane equation, the normal vector of the plane equation may be determined.

It may be known that a product of a point on a plane with a normal vector of a plane equation corresponding to the plane is generally approximately equal to zero, or that a product of any point with a normal vector of a certain plane equation is approximately equal to zero, which means that the point is located on the plane corresponding to the plane equation. Based on this, the threshold range may be set to an interval around zero, for example, [0.1, −0.1], and numerical values of the threshold range may be set according to historical experience, accuracy of the fitted plane, or the like, which is not limited in the embodiment of the disclosure.

Product of the multiple second adjacent points corresponding to the second feature point and the normal vector fall within the threshold range, which means that the multiple second adjacent points corresponding to the second feature point are located in the same plane. Since the second adjacent points are adjacent to the second feature point, the second feature point is also located in the plane, and then the second feature point may be used as the plane point.

It should be noted that in the embodiment of the disclosure, only the process of determining the edge point may be performed, or only the process of determining the plane point may be performed, or the process of determining the edge point and the process of determining the plane point may be performed in a sequential order, which is not limited in the embodiment of the disclosure.

A manner in which the process of determining the edge point and the process of determining the plane point are performed in a sequential order, may occur in a case where a part of feature points in the second feature points are neither edge points nor plane points, and in this case, the part of feature points may be screened out, so that feature points having prominent features may remain in the second feature point set.

In a possible implementation, the operation S13 of determining, according to first feature point sets of the first point clouds and the second feature point set of the second point cloud, the first distance error between the image sensor and the radar sensor may include the following operations.

In operation S131, for any one set of the first feature point sets, matched first feature point pairs are determined according to distances between first feature points in the first feature point set and second feature points in the second feature point set, each of the first feature point pairs includes a first feature point and a second feature point.

As described above, a distance calculation manner known in the art may be used to calculate the distance between the first feature point and the second feature point according to the coordinate of the first feature point and the coordinate of the second feature point. It should be understood that for any one of the first feature points in the first feature point set, a distance between any one of the first feature points and each of the second feature points in the second feature point set may be calculated to determine a second feature point matched with the first feature point.

It should be understood that the smaller the distance between two feature points, the more similar the two feature points, or the higher the probability that the two feature points are the same point on the same object. Based on this, the first feature point and the second feature point between which the distance is smaller than a second distance threshold may be used as the first feature point pairs.

In operation S132, a first sub-error between the first feature point set and the second feature point set is determined according to multiple matched first feature point pairs.

It should be understood that for any one of the first feature points in a first feature point set, a matched second feature point may be determined in a manner of operation S131. Therefore, multiple first feature point pairs may be obtained.

As described above, for the same object in the target scene, data points, indicating the same object in the same coordinate, of the first point cloud and the second point cloud should be coincident or infinitely close, then in theory, the distance between the first feature point and the second feature point in any one of first feature point pairs should be approximately equal to zero.

Based on this, a sum of distances between the first feature points and the second feature points of the multiple first feature point pairs, or an average value of distances between the first feature points and the second feature points of the multiple first feature point pairs may be determined as the first sub-error between the first feature point set and the second feature point set, which is not limited in the embodiment of the disclosure.

In operation S133, the first distance error between the image sensor and the radar sensor is determined according to multiple first sub-errors.

It should be understood that for each of the first feature point sets, a first sub-error between each of the first feature point sets and the second feature point set may be determined in a manner of operations S131 to S132, that is, the first sub-error includes multiple first sub-errors.

In a possible implementation, a sum of the multiple first sub-errors or an average value of the multiple first sub-errors may be determined as the first distance error between the image sensor and the radar sensor, which is not limited in the embodiment of the disclosure.

In the embodiment of the disclosure, the first distance error may be determined effectively according to the matched first feature point pairs.

As described above, the first point cloud is determined based on the radar coordinate system of the radar sensor. The second point cloud is determined based on the global coordinate system. In order to facilitate determination of the first feature point pairs in the first feature point set and the second feature point set, the first point cloud and the second point cloud may be transformed into the same coordinate system.

In a possible implementation, the operation S131 of determining, for any one set of the first feature point sets, matched first feature point pairs according to the distances between the first feature points in the first feature point set and the second feature points in the second feature point set may include the following operations.

For any one set of the first feature point sets, distances between the first feature points in the first feature point set and the second feature points in the second feature point set is determined according to a pose transformation relationship between the radar sensor and the image sensor and a coordinate transformation relationship between a camera coordinate system of the image sensor and the global coordinate system. The first feature point and the second feature point between which the distance is smaller than a second distance threshold are determined as the matched first feature point pair.

As described above, the radar sensor and the image sensor may have fixed positions on the intelligent device, and based on this, the pose transformation relationship between the radar sensor and the image sensor may be unchanged, and the pose transformation relationship may be determined by a historically calibrated pose of the radar and a camera pose of the image sensor, that is, the pose transformation relationship may be known.

The coordinate transformation relationship between the camera coordinate system and the global coordinate system, is a coordinate transformation relationship between the camera coordinate system and the world coordinate system, and external camera parameters of the image sensor may represent the coordinate transformation relationship between the camera coordinate system and the global coordinate system.

In a possible implementation, the first feature point and the second feature point may be transformed into the same coordinate system, that is, into the global coordinate system or the camera coordinate system, according to the pose transformation relationship and the coordinate transformation relationship, and then the distance between the first feature point and the second feature point may be determined according to the coordinate of the first feature point and the coordinate of the second feature point transformed into the same coordinate system.

As described above, the smaller the distance between two feature points, the more similar the two feature points, or the higher the probability that the two feature points are the same point on the same object. Based on this, the first feature point and the second feature point between which the distance is smaller than a second distance threshold may be used as the first feature point pairs.

In the embodiment of the disclosure, the matched first feature point pairs may be effectively determined in the same coordinate system, and the pose transformation relationship between the radar sensor and the image sensor may be introduced into joint calibration of the radar sensor and the image sensor, which is equivalent to introduction of a constraint relationship between the radar sensor and the image sensor, and is beneficial to improve global consistency of the joint calibration among multiple sensors.

As described above, the first feature point and the second feature point may be transformed into the camera coordinate system, according to the pose transformation relationship and the coordinate transformation relationship. In a possible implementation, the determining, for any one set of the first feature point sets, the distances between the first feature points in the first feature point set and the second feature points in the second feature point set according to the pose transformation relationship between the radar sensor and the image sensor and the coordinate transformation relationship between the camera coordinate system of the image sensor and the global coordinate system may include the following operations.

For any one set of the first feature point sets, first positions of the first feature points in the first feature point set in the camera coordinate system is determined according to the pose transformation relationship between the radar sensor and the image sensor. Second positions of the second feature points in the second feature point set under the camera coordinate system is determined according to the coordinate transformation relationship between the camera coordinate system and the global coordinate system. The distances between the first feature points in the first feature point set and the second feature points in the second feature point set is determined according to the first position and the second position.

The first position of the first feature point in the first feature point set under the camera coordinate system is determined according to the pose transformation relationship between the radar sensor and the image sensor. That is, the first feature point is transformed from the radar coordinate system into the camera coordinate system, and the first position of the first feature point in the camera coordinate system is obtained.

The first position of the first feature point in the camera coordinate system may be determined by formula (4): X_{cl}=R_{cl}Xₗ+t_{cl}, here Xₗ represents a position of the first feature point in the radar coordinate system, X_{cl} represents a second position of the first feature point in the camera coordinate system, and a translation matrix R_{cl} and a rotation matrix t_{cl} represent the pose transformation relationship between the radar sensor and the image sensor.

The second position of the second feature point Xₕ in the global coordinate system under the camera coordinate system may be determined by formula (5): X_{ch}=RXₕ+t, that is, the second feature point Xₕ in the global coordinate system is transformed into the camera coordinate system, to obtain the second position X_{ch} of the second feature point in the camera coordinate system, here a rotation matrix R and a translation matrix t represent the coordinate transformation relationship between the camera coordinate system and the global coordinate system (i.e., historically calibrated external camera parameters).

As described above, a distance calculation manner known in the art, such as Euclidean distance, cosine distance, or the like, may be used to determine the distances between the first feature points in the first feature point set and the second feature points in the second feature point set according to the first position and the second position, which is not limited in the embodiment of the disclosure.

In the embodiment of the disclosure, the distance between the first feature point and the second feature point may be effectively calculated in the camera coordinate system, and the pose transformation relationship between the radar sensor and the image sensor may also be introduced into joint calibration of the radar sensor and the image sensor, which is equivalent to introduction of a constraint relationship between the radar sensor and the image sensor, and is beneficial to improve global consistency of the joint calibration.

As described above, the first feature point and the second feature point may be transformed into the global coordinate system according to the pose transformation relationship and the coordinate transformation relationship. In a possible implementation, the determining, for any one set of the first feature point sets, the distances between the first feature points in the first feature point set and the second feature points in the second feature point set according to the pose transformation relationship between the radar sensor and the image sensor and the coordinate transformation relationship between the camera coordinate system of the image sensor and the global coordinate system may further include the following operations.

For any one set of the first feature point sets, second global positions of the first feature points in the first feature point set in the global coordinate system is determined according to the pose transformation relationship between the radar sensor and the image sensor and the coordinate transformation relationship between the camera coordinate system and the global coordinate system.

The distances between the first feature points in the first feature point set and the second feature points in the second feature point set is determined according to the second global positions and first global positions of the second feature points in the second feature point set.

In a possible implementation, the second global position of the first feature point in the global coordinate system may be determined by formula (6): Xₕₗ=R(R_{cl}Xₗ+t_{cl})+t, here R_{cl} and t_{cl} represent the pose transformation relationship between the radar sensor and the image sensor, R and t represent the coordinate transformation relationship between the camera coordinate system and the global coordinate system, Xₗ represents a position of the first feature point in the radar coordinate system, and Xₕₗ represents the second global position of the first feature point in the global coordinate system. Formula (6) represents that the second feature points are transformed from the radar coordinate system into the camera coordinate system and then into the global coordinate system.

As described above, the second point cloud is constructed based on the global coordinate system, and the first global position of the second feature point may be known. A distance calculation manner known in the art, such as Euclidean distance, cosine distance, or the like, may be used to determine the distance between the first feature point and the second feature point according to the first global position and the second global position, which is not limited in the embodiment of the disclosure.

In the embodiment of the disclosure, the distance between the first feature point and the second feature point may be effectively calculated in the global coordinate system, and the pose transformation relationship between the radar sensor and the camera sensor may also be introduced into joint calibration of the radar sensor and the camera sensor, which is equivalent to introduction of a constraint relationship between the radar sensor and the camera sensor, and is beneficial to improve global consistency of the joint calibration.

As described above, the first feature point set may include at least an edge point or a plane point, that is, the first feature point may be an edge point or a plane point. The second feature point set may include at least an edge point or a plane point, that is, the second feature point may be an edge point or a plane point. Accordingly, the first feature point pairs may include at least an edge point pair or a plane point pair. It should be understood that two feature points of the edge point pair may be edge points and two feature points of the plane point pair may be plane points.

In a possible implementation, the operation S132 of determining, according to the multiple matched first feature point pairs, the first sub-error between the first feature point set and the second feature point set may include the following operations.

In operation S1321, for any one of the first feature point pairs, a first vertical distance from a second feature point in the first feature point pair to a straight line where a first feature point in the first feature point pair is located, is determined in response to the first feature point pair being the edge point pair.

It should be understood that two points form a straight line, and in a possible implementation, a first feature point and one first feature point closest to the first feature point may be used to represent a straight line where the first feature point is located. The one first feature point closest to the first feature point may be a feature point, having a closest distance to the first feature point, in the first feature point set. Of course, a straight line formula may also be obtained by using a first feature point and one first feature point closest to the first feature point, to represent, by the straight line formula, the straight line where the first feature point is located.

As described above, the distance between the first feature point and the second feature point may be calculated in the camera coordinate system. In a possible implementation, for the camera coordinate system, the first vertical distance D₁ from the second feature point to the straight line where the first feature point is located may be calculated by formula (7):

$${D}_{1} = \frac{\vert ( {X}_{cl , 1} - {X}_{c h} ) \times ( {X}_{cl , 2} - {X}_{c h} ) \vert}{\vert {X}_{cl , 1} - {X}_{cl , 2} \vert} \qquad ( 7 )$$

$$or$$

$${D}_{1} = \frac{\vert {a}_{0} {X}_{c h} + {b}_{0} {X}_{c h} + {c}_{0} \vert}{\sqrt{{a}_{0}^{2} + {b}_{0}^{2}}}$$

Here X_{cl,1} and X_{cl,2} represent a first position of the first feature point and a first position of one first feature point closest to the first feature point in the camera coordinate system, respectively, X_{ch} represents a second position of the second feature point in the camera coordinate system, a₀, b₀ and c₀ may represent parameters of a straight line formula representing a straight line where the first feature point in the camera coordinate system is located, X_{ch} may be determined by the formula (5), X_{cl,1} and X_{cl,2} may be determined by the formula (4).

As described above, the distance between the first feature point and the second feature point may also be calculated in the global coordinate system. In a possible implementation, for the global coordinate system, the first vertical distance D₁ from the second feature point to the straight line where the first feature point is located may be calculated by formula (8):

$${D}_{1} = \frac{\vert ( {X}_{hl , 1} - {X}_{h} ) \times ( {X}_{hl , 2} - {X}_{h} ) \vert}{\vert {X}_{hl , 1} - {X}_{hl , 2} \vert} \qquad ( 8 )$$

$$or$$

$${D}_{1} = \frac{\vert {a}_{1} {X}_{h} + {b}_{1} {X}_{h} + {c}_{1} \vert}{\sqrt{{a}_{1}^{2} + {b}_{1}^{2}}}$$

Here Xₕ represents a first position of the second feature point in the global coordinate system, X_{hl,1} and X_{hl,2} represent a second global position of the first feature point and a second global position of one first feature point closest to the first feature point in the global coordinate system, respectively, a₁, b₁ and c₁ may represent parameters of a straight line formula representing a straight line where the second feature point in the global coordinate system is located, X_{hl,1} and X_{hl,2} may be determined by the formula (6).

It should be noted that calculation of the first vertical distance from the second feature point in the first feature point pair to the straight line where the first feature point is located is an implementation provided in the embodiment of the disclosure. Actually, the first vertical distance from the first feature point in the first feature point pair to the straight line where the second feature point is located, may also be calculated in the above manner, which is not limited in the embodiment of the disclosure.

Therefore, a more accurate first sub-error may be obtained by calculating the first vertical distance from the second feature point to the straight line where the first feature point is located.

In operation S1322, a second vertical distance from a second feature point in the first feature point pair to a plane where a first feature point in the first feature point pair is located, is determined in response to the first feature point pair being the plane point pair.

It should be understood that three points form a plane, and in a possible implementation, a first feature point and two first feature points closest to the first feature point may be used to represent a plane where the first feature point is located. The two first feature points closest to the first feature point may be feature points, having closest distances to the first feature point, in the first feature point set. Of course, a plane formula may also be obtained by using a first feature point and two first feature points closest to the first feature point, to represent, by the plane formula, the plane where the first feature point is located.

As described above, the distance between the first feature point and the second feature point may be calculated in the camera coordinate system. In a possible implementation, for the camera coordinate system, the second vertical distance D₂ from the second feature point to the plane where the first feature point is located may be calculated by formula (9):

$${D}_{2} = \frac{\vert ( {X}_{cl , 1} - {X}_{c h} ) \times ( {X}_{cl , 2} - {X}_{c h} ) \times ( {X}_{cl , 3} - {X}_{c h} ) \vert}{\vert ( {X}_{cl , 1} - {X}_{cl , 2} ) \times ( {X}_{cl , 1} - {X}_{cl , 3} ) \vert} \qquad ( 9 )$$

$$or$$

$${D}_{2} = \frac{\vert {a}_{2} {X}_{c h} + {b}_{2} {X}_{c h} + {c}_{2} {X}_{c h} + {d}_{2} \vert}{\sqrt{{a}_{2}^{2} + {b}_{2}^{2} + {c}_{2}^{2}}}$$

Here X_{cl,1}, X_{cl,2} and X_{cl,3} represent a first position of the first feature point and first positions of two first feature points closest to the first feature point in the camera coordinate system, respectively, X_{ch} represents a second position of the second feature point in the camera coordinate system, a₂, b₂ and c₂ may represent parameters of a plane formula representing a plane where the first feature point in the camera coordinate system is located, X_{ch} may be determined by the formula (5), X_{cl,1}, X_{cl,2} and X_{cl,3} may be determined by the formula (4).

As described above, the distance between the first feature point and the second feature point may also be calculated in the global coordinate system. In a possible implementation, for the global coordinate system, the first vertical distance D₂ from the second feature point to the straight line where the first feature point is located may be calculated by formula (10):

$${D}_{2} = \frac{\vert ( {X}_{hl , 1} - {X}_{h} ) \times ( {X}_{hl , 2} - {X}_{h} ) \times ( {X}_{hl , 3} - {X}_{h} ) \vert}{\vert ( {X}_{hl , 1} - {X}_{hl , 2} ) \times ( {X}_{hl , 1} - {X}_{hl , 3} ) \vert} \qquad ( 10 )$$

$$or$$

$${D}_{2} = \frac{\vert {a}_{3} {X}_{h} + {b}_{3} {X}_{h} + {c}_{3} {X}_{h} + {d}_{3} \vert}{\sqrt{{a}_{3}^{2} + {b}_{3}^{2} + {c}_{3}^{2}}}$$

Here Xₕ represents a first position of the second feature point in the global coordinate system, X_{hl,1}, X_{hl,2} and X_{hl,3} represent a second global position of the first feature point and second global positions of two first feature points closest to the first feature point in the global coordinate system, respectively, a₃, b₃, c₃ and d₃ may represent parameters of a plane formula representing a plane where the first feature point in the global coordinate system is located, X_{hl,1}, X_{hl,2} and X_{hl,3} may be determined by the formula (6).

It should be noted that calculation of the second vertical distance from the second feature point in the first feature point pair to the plane where the first feature point is located is an implementation provided in the embodiment of the disclosure. Actually, the second vertical distance from the second feature point in the first feature point pair to the plane where the first feature point is located, may also be calculated in the above manner, which is not limited in the embodiment of the disclosure.

Therefore, a more accurate first sub-error may be obtained by calculating the second vertical distance from the second feature point to the plane where the first feature point is located.

In operation S1323, the first sub-error is determined according to at least multiple first vertical distances or multiple second vertical distances.

It should be understood that for each of the first feature point pairs, the first vertical distance and the second vertical distance may be calculated according to operation S1321 and/or operation S1322. Therefore, the first vertical distance and the second vertical distance may include multiple first vertical distances and multiple second vertical distances, respectively.

In a possible implementation, the determining the first sub-error according to at least multiple first vertical distances or multiple second vertical distances may include the following operations. A first vertical distance error is determined according to the multiple first vertical distances, and/or a second vertical distance error is determined according to the second vertical distances. The first vertical distance error or the second vertical distance error is determined as the first sub-error, or, a sum of the first vertical distance error and the second vertical distance error is determined as the first sub-error. That is, the first sub-error includes at least multiple first vertical distance errors or multiple second vertical distance errors.

In a possible implementation, the first vertical distance error H₁ and the second vertical distance error H₂ may be determined by formula (11) and formula (12), respectively:

$${H}_{1} = {\sum }_{q ∈ Q} {‖ {D}_{1}^{q} ‖}_{{\sum }_{q , ( cl , 1 ) , ( cl , 2 )}^{- 1}}^{2} \qquad ( 11 )$$

$${H}_{2} = {\sum }_{q ∈ Q} {‖ {D}_{2}^{q} ‖}_{{\sum }_{q , ( cl , 1 ) , ( cl , 2 ) , ( cl , 3 )}^{- 1}}^{2} \qquad ( 12 )$$

Here Q may represent the number of multiple first feature point pairs or may represent the number of second feature points in the second feature point set, q may represent the q-th first feature point pair of the multiple first feature point pairs or may represent the q-th second feature point in the second feature point set Q, D₁^{q} represents a first vertical distance of the q-th second feature point pair, D₂^{q} represents a second vertical distance of the q-th second feature point pair, and ∥ ∥_{P}² represents square of a P-norm, P=Σ_{q,(cl,1),(cl,2)}⁻¹ or Σ_{q,(cl,3),(cl,2),(cl,3)}⁻¹.

It should be understood that for each of the first feature point sets, a first sub-error between each of the first feature point sets and the second feature point set may be determined in a manner of operations S131 to S133, that is, the first sub-error includes multiple first sub-errors.

As described above, a sum of the multiple first sub-errors or an average value of the multiple first sub-errors may be determined as the first distance error between the image sensor and the radar sensor, which is not limited in the embodiment of the disclosure. In a possible implementation, the first distance error F₁ may be expressed as formula (13):

F₁=F_{1,1}+F_{1,2}, F_{1,1}=Σ_{g∈G}H₁^{g},F_{1,2}=Σ_{g∈G}H₂^{g} (13)

Here G represents the number of multiple first feature point sets, g represents the g-th first feature point set of the multiple first feature point sets, H₁^{g} represents a first vertical distance error corresponding to the g-th first feature point set, and H₂^{g} represents a second vertical distance error corresponding to the g-th first feature point set. Formula (13) may represent summation of multiple first sub-errors to obtain the first distance error.

In the embodiment of the disclosure, a more accurate first sub-error may be obtained by calculating vertical distance errors from a point to a line and from a point to a plane, and then a more accurate first distance error may be obtained.

In a possible implementation, the operation S14 of determining, according to the multiple first feature point sets, the second distance error of the radar sensor may include the following operations.

In operation S141, matched second feature point pairs are determined according to distances between third feature points in a third feature point set and fourth feature points in a fourth feature point set, the third feature point set and the fourth feature point set are any two of the first feature point sets, and each of the second feature point pairs includes a third feature point and a fourth feature point.

As described above, the multiple first point clouds are point clouds acquired by the radar sensor at different positions of the target scene. Since the radar sensor may have different radar poses at different positions, there may also be errors between the first point clouds acquired by the radar sensor at different positions. The first feature point set of the first point cloud may be understood as a set of feature points in the first point cloud.

The third feature point set and the fourth feature point set may be two first feature point sets, adjacent to each other in the acquisition timing, of multiple first feature point sets, or may be two first feature point sets selected at an interval, which is not limited in the embodiment of the disclosure.

A distance calculation method known in the art may be used to calculate the distance between the third feature point and the fourth feature point according to the coordinate of the third feature point and coordinate of the fourth feature point. It should be understood that for any one of the third feature points in the third feature point set, a distance between any one of the third feature points and each of the fourth feature points in the fourth feature point set may be calculated to determine a fourth feature point matched with the third feature point.

It should be understood that the smaller the distance between two feature points, the more similar the two feature points, or the higher the probability that the two feature points are the same point on the same object. Based on this, the third feature point and the fourth feature point between which the distance is smaller than a third distance threshold may be used as the first feature point pairs.

It should be understood that a fourth feature point matched with each of the third feature points in the third feature point set may be determined in a manner of operation S141. Therefore, multiple second feature point pairs may be obtained.

In operation S142, a second sub-error between the third feature point set and the fourth feature point set is determined according to multiple matched second feature point pairs.

As described above, for the same object in the target scene, data points, indicating the same object in the same coordinate, of the first point clouds acquired at different positions should be coincident or infinitely close, then in theory, the distance between the third feature point and the fourth feature point in any one of second feature point pairs should be approximately equal to zero.

Based on this, a sum of distances between the third feature points and the fourth feature points of the multiple second feature point pairs, or an average value of distances between the third feature points and the fourth feature points of the multiple second feature point pairs may be determined as the second sub-error between the third feature point set and the fourth feature point set, which is not limited in the embodiment of the disclosure.

In operation S143, the second distance error of the radar sensor is determined according to multiple second sub-errors.

It should be understood that for any two of the first feature point sets, a second sub-error corresponding to any two of the first feature point sets may be determined in a manner of operations S141 to S142, that is, the second sub-error includes multiple second sub-errors.

In a possible implementation, a sum of the multiple second sub-errors or an average value of the multiple second sub-errors may be determined as the second distance error of the radar sensor, which is not limited in the embodiment of the disclosure.

In the embodiment of the disclosure, the second distance error may be determined effectively according to the matched second feature point pairs.

As described above, the radar sensor may have different radar poses at the time of acquiring each of the first point clouds, which means that coordinate of each of the first point clouds may not be uniform. In order to determine the second feature point pair between any two of the first feature point sets, each of the first feature point sets may be transformed into the same coordinate system. In a possible implementation, the operation S141 of determining matched second feature point pairs according to the distances between the third feature points in the third feature point set and the fourth feature points in the fourth feature point set may include the following operations.

The distances between the third feature points in the third feature point set and the fourth feature points in the fourth feature point set is determined according to a radar pose of the radar sensor acquiring each of the first point clouds. The third feature point and the fourth feature point between which the distance is smaller than a third distance threshold is determined as the matched second feature point pair.

As described above, the radar pose of the radar sensor acquiring each of the first point clouds may be determined by a combined inertial navigation system, a global satellite navigation system, and/or an inertial navigation system, or the like installed on the intelligent device, which is not limited in the embodiment of the disclosure.

It should be understood that the radar pose may represent a coordinate transformation relationship between the radar coordinate system of the radar sensor and the global coordinate system, or a pose transformation relationship of the radar sensor with respect to the global coordinate system. Each of the first feature point sets may be directly transformed into the global coordinate system according to the radar pose when each of the first point clouds is acquired, and then the distance between the third feature point and the fourth feature point may be determined according to coordinates of the third feature point and the fourth feature point which are transformed into the global coordinate system.

In a possible implementation, a relative radar pose corresponding to any two of the first feature point sets may also be determined according to the radar pose of the radar sensor acquiring each of the first point clouds, and then the third feature point set and the fourth feature point set are transformed into the same coordinate system according to the relative radar pose, for example, into a radar coordinate system of the radar sensor acquiring one of the first point clouds, which is not limited in the embodiment of the disclosure.

As described above, the smaller the distance between two feature points, the more similar the two feature points, or the higher the probability that the two feature points are the same point on the same object. Based on this, the third feature point and the fourth feature point between which the distance is smaller than a third distance threshold may be used as the second feature point pairs.

In the embodiment of the disclosure, the matched second feature point pairs may be effectively determined in the same coordinate system, and the pose error of the radar sensor itself may be introduced into joint calibration, which is beneficial to improve accuracy of the joint calibration.

As described above, the first feature point set may be transformed into the global coordinate system. In a possible implementation, the determining, according to the radar pose of the radar sensor acquiring each of the first point clouds, the distances between the third feature points in the third feature point set and the fourth feature points in the fourth feature point set may include the following operations.

Third global positions of the third feature points in the third feature point set in the global coordinate system and fourth global positions of the fourth feature points in the fourth feature point set in the global coordinate system are determined according to the radar pose of the radar sensor acquiring each of the first point clouds. The distances between the third feature points in the third feature point set and the fourth feature points in the fourth feature point set is determined according to the third global position and the fourth global position.

The determining the third global position of the third feature point in the global coordinate system and the fourth global position of the fourth feature point in the global coordinate system respectively according to the radar pose of the radar sensor acquiring each of the first point clouds may be understood as transformation of the third feature point and the fourth feature point in the radar coordinate system into the global coordinate system, to obtain the third global position of the third feature point in the global coordinate system and the fourth global position of the fourth feature point in the global coordinate system.

In a possible implementation, the third global position of the third feature point in the global coordinate system and the fourth global position of the fourth feature point in the global coordinate system may be determined by formula (14): Xₕₗ_{₀}=RₗXₗ+tₗ, here a translation matrix Rₗ and a rotation matrix tₗ represent the radar pose, Xₗ represents positions of the third feature point and the fourth feature point in the radar coordinate system, and Xₕₗ_{₀} represents the third global position of the third feature point in the global coordinate system or the fourth global position of the fourth feature point in the global coordinate system.

As described above, a distance calculation manner known in the art, such as Euclidean distance, cosine distance, or the like, may be used to determine the distances between the third feature points in the third feature point set and the fourth feature points in the fourth feature point set according to the third global position and the fourth global position, which is not limited in the embodiment of the disclosure.

In the embodiment of the disclosure, the matched second feature point pairs may be effectively determined in the global coordinate system, and the pose error of the radar sensor itself may also be introduced into joint calibration, which is beneficial to improve accuracy of the joint calibration.

As described above, the second feature point set may include at least an edge point or a plane point, that is, the first feature point may be an edge point or a plane point. Accordingly, the second feature point pairs may include at least an edge point pair or a plane point pair. It should be understood that two feature points of the edge pair may be edge points, and two feature points of the plane point pair may be plane points.

In a possible implementation, the operation S142 of determining, according to the multiple matched second feature point pairs, the second sub-error between the third feature point set and the fourth feature point set may include the following operations.

In operation S1421, for any one of the second feature point pairs, a third vertical distance from a third feature point in the second feature point pair to a straight line where a fourth feature point in the second feature point pair is located, is determined in response to the second feature point pair being the edge point pair.

As described above, two points form a straight line, and in a possible implementation, a fourth feature point and one fourth feature point closest to the fourth feature point may be used to represent a straight line where the fourth feature point is located. The one fourth feature point closest to the fourth feature point may be a feature point, having a closest distance to the fourth feature point, in the fourth feature point set. Of course, a straight line formula may also be obtained by using a fourth feature point and one fourth feature point closest to the fourth feature point, to represent, by the straight line formula, the straight line where the fourth feature point is located.

In a possible implementation, the third vertical distance D₃ may be calculated by referring to calculation of the first vertical distance according to formula (8), that is, the third global position of the third feature point in the global coordinate system may be used as Xₕ, the fourth feature point and the one fourth feature point closest to the fourth feature point may be used as X_{hl,1}, X_{hl,2}, respectively, and parameters of the straight line formula of the straight line where the fourth feature point is located may be used as a₁, b₁ and c₁, which are not elaborated here. It should be understood that unlike formula (8), the third global position of the third feature point and the fourth global position of the fourth feature point in the embodiment of the disclosure are global positions determined by formula (14).

It should be noted that calculation of the third vertical distance from the third feature point in the second feature point pair to the straight line where the fourth feature point is located is an implementation provided in the embodiment of the disclosure. Actually, the third vertical distance from the fourth feature point in the second feature point pair to the straight line where the third feature point is located, may also be calculated in the above manner, which is not limited in the embodiment of the disclosure.

Therefore, a more accurate second sub-error may be obtained by calculating the third vertical distance from the third feature point to the straight line where the fourth feature point is located.

In operation S1422, a fourth vertical distance from a third feature point in the second feature point pair to a plane where a fourth feature point in the first feature point pair is located, is determined in response to the second feature point pair being the plane point pair.

As described above, three points form a plane, and in a possible implementation, a fourth feature point and two fourth feature points closest to the fourth feature point may be used to represent a plane where the fourth feature point is located. The two fourth feature points closest to the fourth feature point may be two feature point, having closest distances to the fourth feature point, in the fourth feature point set. Of course, a plane formula may also be obtained by using a fourth feature point and two fourth feature points closest to the fourth feature point, to represent, by the plane formula, the plane where the fourth feature point is located.

In a possible implementation, the fourth vertical distance D₄ may be calculated by referring to calculation of the second vertical distance according to formula (10), that is, the third global position of the third feature point in the global coordinate system may be used as Xₕ, the fourth feature point and two fourth feature points closest to the fourth feature point may be used as X_{hl,1}, X_{hl,2}, X_{hl,3}, respectively, and parameters of the plane formula of the plane where the fourth feature point is located may be used as a₃, b₃, c₃, d₃, which are not elaborated here. It should be understood that unlike formula (10), the third global position of the third feature point and the fourth global position of the fourth feature point in the embodiment of the disclosure are determined by formula (14).

It should be noted that calculation of the fourth vertical distance from the third feature point in the second feature point pair to the plane where the fourth feature point is located is an implementation provided in the embodiment of the disclosure. Actually, the fourth vertical distance from the fourth feature point in the second feature point pair to the plane where the third feature point is located, may also be calculated in the above manner, which is not limited in the embodiment of the disclosure.

Therefore, a more accurate second sub-error may be obtained by calculating the fourth vertical distance from the third feature point to the plane where the fourth feature point is located.

In operation S1423, the second sub-error is determined according to at least multiple third vertical distances or multiple fourth vertical distances.

It should be understood that for each of the second feature point pairs, the third vertical distance and the fourth vertical distance may be calculated according to operation S1421 and/or operation S1422. Therefore, the third vertical distance and the fourth vertical distance may include multiple third vertical distances and multiple fourth vertical distances, respectively.

In a possible implementation, the determining the second sub-error according to at least multiple third vertical distances or multiple fourth vertical distances may include the following operations. A third vertical distance error is determined according to the multiple third vertical distances, and/or a fourth vertical distance error is determined according to the fourth vertical distances. The third vertical distance error or the fourth vertical distance error is determined as the second sub-error, or, a sum of the third vertical distance error and the fourth vertical distance error is determined as the second sub-error. That is, the second sub-error includes at least multiple third vertical distance errors or multiple fourth vertical distance errors.

In a possible implementation, the third vertical distance error H₃ and the fourth vertical distance error H₄ may be determined by referring to determination of the first vertical distance and the second vertical distance according to formula (11) and formula (12), respectively, which is not elaborated here.

It should be understood that for multiple first feature point sets, a second sub-error between any two of the first feature point sets may be determined in a manner of operations S141 to S143, that is, the second sub-error includes multiple second sub-errors.

As described above, a sum of the multiple second sub-errors or an average value of the multiple second sub-errors may be determined as the second distance error of the radar sensor, which is not limited in the embodiment of the disclosure. In a possible implementation, the second distance error F₂ may be expressed as formula (15):

F₂=F_{2,1}+F_{2,2},F_{2,1}=Σ_{g∈G}H₃^{g},F_{2,2}=Σ_{g∈G}H₄^{g} (15)

Here G represents the number of multiple first feature point sets, g represents the g-th first feature point set (i.e., the g-th third feature point set) of the multiple first feature point sets, H₃^{g} represents a third vertical distance error corresponding to the g-th third feature point set, and H₄^{g} represents a fourth vertical distance error corresponding to the g-th third feature point set. Formula (15) may represent summation of multiple second sub-errors to obtain the second distance error.

In the embodiment of the disclosure, a more accurate second sub-error may be obtained by calculating vertical distance errors from a point to a line and from a point to a plane, and then a more accurate second distance error may be obtained.

In a possible implementation, the operation S15 of determining the reprojection error of the image sensor according to the first global position of the second feature point set in the global coordinate system and the first image positions of pixel points corresponding to the second feature point set in the multiple scene images may include the following operations.

In operation S151, for any one of the scene images, according to a first global position of any one of second feature points in the second feature point set and camera parameters of the image sensor, a second image position of the second feature point in the scene image is determined.

A camera imaging principle, such as an aperture imaging principle model shown in formula (16) may be used to determine the second image position of the second feature point in the scene image according to the first global position of the second feature point and camera parameters.

s[x^{t}]^{T}=K[Rt][Xₕ]^{T} (16)

Here s is an arbitrary scale factor, [Xₕ]^{T} represents a matrix of the first global position, [x^{t}]^{T} represents a matrix of the second image position x^{t}, K represents an internal parameter matrix of the camera, [Rt] represents an external parameter matrix of the camera, R represents a rotation matrix, and t represents a translation matrix. It should be understood that the first global position is 3D coordinate and the second image position is 2D coordinate.

It should be understood that for each of the second feature points, the second image position of each of the second feature points in the scene image may be obtained by formula (16).

In operation S152, a reprojection sub-error corresponding to the scene image is determined according to second image positions of multiple second feature points and first image positions of pixel points corresponding to the multiple second feature points in the scene image.

It should be understood that the second image position, i.e., a coordinate of a projection point of the second feature point in the image coordinate system (i.e., the scene image) of the image sensor, is obtained by formula (16), and the projection point is a 2D point calculated according to historically calibrated camera parameters, and the pixel points corresponding to the second feature points may be understood as 2D points in an actually captured scene image.

As described above, in theory, the projection point of the second feature point coincides with the pixel point corresponding to the second pixel point. Since there may be an error between camera parameters for calculating the projection point and actual camera parameters of the image sensor, and there may also be an error between the second point cloud constructed based on the scene image and the target scene, there may be an error between the projection point and the pixel point, that is, positions of the projection point and the pixel point do not coincide. The error between the projection point and the pixel point is known as the reprojection error.

In a possible implementation, a distance between the projection point and the pixel point may be used as the error between the projection point and the pixel point, and the distance between the projection point and the pixel point may be determined based on a coordinate of the projection point (i.e., the second image position of the second feature point) and a coordinate of a corresponding pixel point (i.e., the first image position), and then, a sum of distances between multiple projection points and corresponding pixel points is determined as the reprojection sub-error corresponding to the scene image.

In a possible implementation, the reprojection sub-error H₅ corresponding to the scene image may also be determined by formula (17):

H₅=Σ_{j∈J}∥xₗ−xⱼ^{t}∥² (17)

Here J represents the number of multiple second feature points, q represents the j-th second feature point of the multiple second feature points, xⱼ represents a first image position of the projection point corresponding to the j-th second feature point, xⱼ^{t} represents a second image position of the projection point corresponding to the j-th second feature point and is calculated by formula (16), and ∥ ∥² represents square of a norm. Formula (17) represents that a sum of square values of the norm of difference values between second image positions of the multiple second feature points and second image positions of corresponding pixel points, is determined as the reprojection sub-error.

It should be understood that for each of scene images, a reprojection sub-error corresponding to each of the scene images may be obtained in a manner of operations S151 to S152.

In operation S153, the reprojection error of the image sensor is determined according to reprojection sub-errors corresponding to the multiple scene images.

In a possible implementation, the determining the reprojection error of the image sensor according to reprojection sub-errors corresponding to the multiple scene images may include the following operations. A sum of reprojection sub-errors corresponding to the multiple scene images may be determined as the reprojection error F_{3,1} of the image sensor, according to formula (18): F_{3,1}=Σ_{e∈E}H₅^{e}, here E represents the number of the multiple scene images, and e represents the e-th scene image of the multiple scene images. Or, an average value of reprojection sub-errors corresponding to the multiple scene images may also be determined as the reprojection error of the image sensor, which is not limited in the embodiment of the disclosure.

As described above, the image sensor may include multiple image sensors. It should be understood that when the image sensor includes multiple image sensors, each of the image sensors may obtain the reprojection error corresponding to each of the image sensors according to operations S151 to S153, which is not elaborated here.

In the embodiment of the disclosure, the reprojection error of the image sensor may be obtained effectively, so that the reprojection error of the image sensor may be introduced into joint calibration, which is beneficial to improve calibration accuracy of the image sensor.

As described above, the image sensor includes multiple image sensors, and the reprojection error of each of the image sensors is determined according to operations S151 to S153, so that the multiple image sensors are calibrated independent of each other, which is not beneficial to achieve global consistency of the joint calibration among multiple sensors.

In a possible implementation, in case of multiple image sensors, any one of the image sensors may be selected as a reference image sensor, and other image sensors are non-reference image sensors, and then a pose transformation relationship between the reference image sensor and the non-reference image sensor is introduced into joint calibration of the multiple image sensors. Therefore, it is equivalent to introduction of a constraint relationship among the multiple image sensors, which is beneficial to improve global consistency of the joint calibration among multiple sensors and improve calibration accuracy of the sensor.

The pose transformation relationship between the reference image sensor and the non-reference image sensor may be obtained according to a rigid transformation between a historically calibrated camera pose of the reference image sensor and a historically calibrated camera pose of the non-reference image sensor.

In a possible implementation, in case of multiple image sensors, the multiple image sensors includes a reference image sensor and at least one non-reference image sensor. Based on this, the multiple scene images may include multiple reference images acquired by the reference image sensor and multiple non-reference images acquired by the non-reference image sensor.

In a possible implementation, the operation S15 of determining the reprojection error of the image sensor according to the first global position of the second feature point set in the global coordinate system and the first image positions of pixel points corresponding to the second feature point set in the multiple scene images may include the following operations.

In operation S154, for any one of non-reference images, according to a first global position of any one of second feature points in the second feature point set, camera parameters of the reference image sensor and a pose transformation relationship between the non-reference image sensor and the reference image sensor, a third image position of the second feature point in the non-reference image is determined.

The second feature point may be projected into an image coordinate system (i.e., the reference image) of the reference image sensor according to camera parameters of the reference image sensor and the first global position of the second feature point based on the camera imaging principle shown in formula (16). Then, the coordinate of the second feature point in the image coordinate system of the reference image sensor are transformed into an image coordinate system of the non-reference image sensor according to the pose transformation relationship between the non-reference image sensor and the reference image sensor, to obtain the third image position of the second feature point in the non-reference image sensor.

For example, formula (19) may be used to transform the second feature point in the image coordinate system of the reference image sensor into the image coordinate system (i.e., the non-reference image) of the non-reference image sensor according to the pose transformation relationship between the non-reference image sensor and the reference image sensor:

xⱼ^{f}=R_{cf}xⱼ^{c}+t_{cf} (19)

Here xⱼ^{f} represents a third image position of the j-th second feature point in the non-reference image, xⱼ^{c} represents an image position of the j-th second feature point in the image coordinate system of the reference image sensor and is calculated by formula (16), R_{cf} and t_{cf} represent the pose transformation relationship between the non-reference image sensor and the reference image sensor, R_{cf} represents a rotation matrix, and t_{cf} represents a translation matrix.

It should be understood that for each of second feature points, the third image position corresponding to each of the second feature points may be obtained according to operation S154.

In operation S155, a reprojection sub-error corresponding to the non-reference image is determined according to third image positions of multiple second feature points and first image positions of pixel points corresponding to the second feature points in the non-reference image.

In a possible implementation, a sum of distances between the third image positions of the multiple second feature points and the first image positions of corresponding pixel points may be determined as the reprojection sub-error corresponding to the non-reference image.

In a possible implementation, the reprojection sub-error H₆ corresponding to the non-reference image may also be determined by formula (20):

H₆=Σ_{j∈J}∥xⱼ−xⱼ^{f}∥² (20)

Here J represents the number of multiple second feature points, j represents the j-th second feature point of the multiple second feature points, xⱼ represents a first image position of the pixel point corresponding to the j-th second feature point, xⱼ^{f} represents a third image position corresponding to the j-th second feature point and is calculated by formula (19), and ∥ ∥² represents square of a norm. Formula (20) represents that a sum of square values of the norm of difference values between third image positions of the multiple second feature points and first image positions of corresponding pixel points, is determined as the reprojection sub-error.

It should be understood that for each of non-reference images, a reprojection sub-error corresponding to each of the non-reference images may be obtained in a manner of operations S154 to S155.

In operation S156, the reprojection error of the non-reference image sensor is determined according to reprojection sub-errors corresponding to the multiple non-reference images.

In a possible implementation, the determining the reprojection error of the non-reference image sensor according to reprojection sub-errors corresponding to the multiple non-reference images may include the following operations. A sum of reprojection sub-errors corresponding to the multiple non-reference images may be determined as the reprojection error F_{3,2} of the non reference image sensor, according to formula (21): F_{3,2}=Σ_{e*∈E*}H₆^{e*}, here E* represents the number of the multiple non-reference images, and e* represents the e*-th non-reference image of the multiple non-reference images. H₆^{e*} represents a reprojection sub-error of the e*-th non-reference image. Or, an average value of reprojection sub-errors corresponding to the multiple non-reference images may also be determined as the reprojection error of the non-reference image sensor, which is not limited in the embodiment of the disclosure.

In a possible implementation, the reprojection error of the reference image sensor may be determined by referring to operations S151 to S153, that is, the reprojection error of the reference image sensor may be expressed as F_{3,1}, which is not elaborated here.

Based on this, in a case where the image sensor includes a reference image sensor and at least one non-reference image sensor, the reprojection error of the image sensor may be expressed as formula (22): F₃=F_{3,1}+Σ_{w*∈W*}F_{3,2}^{w*} here W* represents the number of multiple non-reference image sensors, w* represents the w*-th non-reference image sensor of the multiple non-reference image sensors, and F_{3,2}^{w*} represents the reprojection error of the w*-th non-reference image sensor.

In the embodiment of the disclosure, the reprojection error of the multiple image sensors may be obtained effectively, and the pose transformation relationship between the multiple image sensors is introduced into joint calibration of the multiple image sensors, which is equivalent to introduction of a constraint relationship among the multiple image sensors, and is beneficial to improve global consistency of the joint calibration among the multiple image sensors, and improve accuracy of the joint calibration among the multiple image sensors.

In a possible implementation, the operation S16 of calibrating the radar sensor and the image sensor according to the first distance error, the second distance error and the reprojection error, to obtain the first calibration result of the radar sensor and the second calibration result of the image sensor may include the following operations.

In operation S161, a radar pose of the radar sensor, camera parameters of the image sensor and the second feature point set are optimized according to the first distance error, the second distance error and the reprojection error.

An optimization algorithm known in the art, such as a Bundle Adjustment (BA) algorithm, may be used to optimize the radar pose of the radar sensor, camera parameters of the image sensor and the second feature point set according to the first distance error, the second distance error and the reprojection error, which is not limited in the embodiment of the disclosure.

It should be understood that the second point cloud is constructed by multiple scene images, and the second feature point set is optimized, so that an error between the second feature point set and an actual point cloud corresponding to the target scene may be reduced to improve calibration accuracy of the sensor.

In operation S161, the sensor calibration method is re-performed according to the optimized radar pose, optimized camera parameters and optimized second feature point set, until the radar pose of the radar sensor and the camera parameters of the image sensor are converged respectively, to obtain the first calibration result of the radar sensor and the second calibration result of the image sensor, the first calibration result includes the converged radar pose, and the second calibration result includes the converged camera parameters.

The sensor calibration method may be re-performed according to the optimized radar pose, optimized camera parameters and optimized second feature point set, by referring to operations of the sensor calibration method according to the embodiment of the disclosure, which is not elaborated here.

It should be understood that the sensor calibration method may be performed many times, each time new radar pose and camera parameters may be obtained. In a possible implementation, when the radar pose of the radar sensor and the camera parameters of the image sensor are converged respectively, the converged radar pose and the converged camera parameters may be used as the first calibration result of the radar sensor and the second calibration result of the image sensor, respectively. Or, in a case where the number of times of performing the sensor calibration method satisfies a preset number of iterations (for example, three iterations), an execution result (i.e., the radar pose and camera parameters) of the last sensor calibration method may be used as the first calibration result of the radar sensor and the second calibration result of the image sensor, respectively.

In the embodiment of the disclosure, by performing the sensor calibration method iteratively, the calibration result of each of the radar sensor and the image sensor may be more accurate.

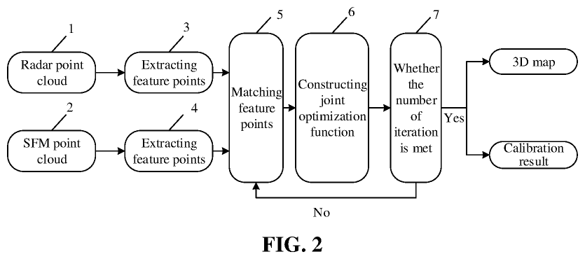

FIG. 2 shows a schematic diagram of a sensor calibration method according to an embodiment of the disclosure. As shown in FIG. 2, the sensor calibration method includes the following operations.

In a first operation, radar point clouds of multiple frames acquired by a laser radar installed on an intelligent vehicle is acquired.

In a second operation, a SFM point cloud constructed based on a scene image is acquired, the scene image includes multiple scene images of a target scene acquired by at least one camera installed on the intelligent vehicle.

In a third operation, feature points are extracted from the radar point cloud.

For radar point clouds of single frame, a horizontal angle and a vertical angle of each laser emission point are calculated, and the radar point clouds of single frame are arranged in an order according to the horizontal angle and the vertical angle. The horizontal angle and the vertical angle of each laser emission point may be calculated by referring to formula (1) and formula (2), which is not elaborated here.

After the horizontal angle and the vertical angle are obtained, the vertical angle of each laser emission point may be allocated to different beams of the laser emission point according to angle values in the vertical direction, and the radar point clouds are sorted according to vertical angles of the different beams, so that the radar point clouds are arranged in the vertical direction. Furthermore, the radar point clouds are arranged horizontally according to angle values in the horizontal direction. At this time, all the laser emission points have fixed relative positions, that is, an ordered point cloud sequence is obtained. When a sequence relationship (arrangement relationship) of the radar point clouds is obtained, a curvature of a current point may be obtained according to an adjacent point set by referring to formula (3), the adjacent point set includes multiple points adjacent to the current point.

In the process of calculating the curvature, five adjacent points arranged at the left and right of the current point may be selected as the adjacent point set of the current point. After the curvature of each of the points is obtained, the points are sorted according to values of the curvature. A point having a large curvature is considered as an edge point, and a point having a small curvature is considered as a plane point.

In a fourth operation, feature points are extracted from the SFM point cloud.

In the process of extracting the feature points from the SFM point cloud, a KD-tree may be created and used to manage the SFM point cloud, ten points closest to each point are searched in the KD-tree, and a distance between each point and each of the closest ten points may be calculated respectively. When the distance is smaller than a certain threshold, the point is used as a feature point, otherwise, the point is not used as the feature point. When the current point is the feature point, a feature attribute of the current point is determined according to ten points closest to the feature point, that is, the feature point is partitioned into an edge point or a plane point.

The determination of the edge point includes the following operations. A covariance matrix of an adjacent point set formed by 10 closest points is calculated and the covariance matrix is decomposed by SVD to obtain a multi-dimensional feature value and a multi-dimensional feature vector. When a certain-dimensional feature value is much greater than other-dimensional feature values, the current point is considered as the edge point. The determination of the plane point includes the following operations. A plane is fitted according to 10 closest points, and a normal vector of the plane is solved. When product of each point in the point set and the normal vector is approximately equal to zero, the current point is considered as the plane point.

In a fifth operation, feature point matching is performed, including feature point matching between the radar point cloud and the radar point cloud, and feature point matching between the radar point cloud and the SFM point cloud.

The feature point matching between the radar point cloud and the radar point cloud may refer to the process of obtaining the second feature point pair according to the embodiment of the disclosure, which is not elaborated here.

In a possible implementation, all radar point clouds may be transformed into the global coordinate system according to an initial radar pose, that is, all radar point clouds are located in the same coordinate system. Then, edge points and plane points are extracted from a radar point cloud of current frame, and matched feature points closest to a radar point cloud of adjacent frame are searched. In the matching process, a distance between the edge point in the current frame radar point cloud and a line where the edge point in the radar point cloud of adjacent frame is located is calculated, and a distance between the plane point in the radar point cloud of current frame and a plane where the edge point in the radar point cloud of adjacent frame is located is calculated. When the distance is smaller than a certain threshold (for example, 1 m), it is determined that two points in radar point clouds of two frames are matched. In this case, a distance error function from the radar point cloud of current frame to the point-line and the point-plane of a matched feature point set in the radar point cloud of adjacent frame may be constructed, and an optimization variable is a radar pose of a current laser radar.

The feature point matching between the radar point cloud and the SFM point cloud may refer to the process of obtaining the first feature point pair according to the embodiment of the disclosure, which is not elaborated here.

It should be understood that a relative pose between the laser radar and the camera is fixed, therefore an idea of a generalized camera model may be used to introduce the laser radar into the generalized camera model. For example, in a multi-sensor system having four cameras and one laser radar, a reference camera (a reference image sensor) is selected, and the remaining cameras (non-reference image sensors) and the laser radar are not optimized individually. The generalized camera model refers to rigid fixing between a camera and a camera, without changing the relative pose.

Pose transformation relationships between the remaining cameras, the laser radar and the reference camera are obtained by historical calibration, and poses of the remaining cameras and the laser radar in the global coordinate system are obtained by using a pose transformation relationship between the reference camera and the global coordinate system. Such indirect optimization process ensures that at a position where the intelligent vehicle stops, a relative pose among multiple sensors does not change and an optimization model (i.e., a joint optimization function) is not changed by change of the relative pose.

In a sixth operation, a joint optimization function is constructed according to a feature matching result.

The joint optimization function is mainly composed of a reprojection error function, a distance error function between the SFM point cloud and the radar point cloud, and a distance error function between the radar point clouds of different frames. As described above, the reprojection error may be optimized by a way of the generalized camera model. A pose relationship from the reference camera to the global coordinate system may be optimized when the reprojection error is optimized, other sensors are indirectly optimized to a calibrated pose relationship of the reference camera, and then optimized to the pose relationship from the reference camera to the global coordinate system. Therefore, it may ensure that a relative pose among multiple sensors has a rigid relationship, which is beneficial to global consistency of the joint optimization among multiple sensors, and improve calibration accuracy of the sensor.

The joint optimization function may be expressed as formula (23).

F*=F*₁+F*₂+F*₃ (23)

Here F*₁ represents the reprojection error function, see formula (24).

F*=F*_{1,1}+F*_{1,2} (24)

Here F*_{1,1} represents the reprojection error function of the reference camera, see formula (25).

F*_{1,1}=Σ_{J}Σ_{E}∥x_{j,e}−r(K,R,t,Xₕ^{j})∥² (25)

Here j represents the j-th feature point in the SFM point cloud, j ∈ J, E* represents the number of scene images acquired by the reference camera, e ∈ E , e represents the e-th scene image captured by the reference camera, x_{j,e} represents a 2D coordinate of a pixel point corresponding to the j-th feature point in the SFM point cloud within the e-th scene image, R and t represent external camera parameters of the reference camera, K represents internal camera parameters of the reference camera, Xₕ^{j} represents a 3D coordinate of the j-th feature point in the SFM point cloud under the global coordinate system, and r(K,R,t,Xₕ^{j})represents a 2D coordinate of a projection point projecting the j-th feature point in the SFM point cloud to the image coordinate system of the reference camera.

Here F*_{1,2} represents the reprojection error function of other cameras (non-reference cameras), see formula (26).

F*_{1,2}=Σ_{J}ΣE*∥x_{j,e*}−r(K,R,t,R_{cf},t_{cf},Xₕ^{j})∥² (26)

Here E* represents the number of scene images acquired by the non-reference camera, e* ∈ E*, e* represents the e*-th scene image (i.e., a non-reference image) captured by the non-reference camera, R_{cf} and t_{cf} represent a pose transformation relationship between the non-reference camera and the reference camera, x_{j,e*} represents a 2D coordinate of a pixel point corresponding to the j-th feature point in the SFM point cloud within the e*-th scene image captured by the non-reference camera, and r(K,R,t,R_{cf},t_{cf},Xₕ^{j}) represents a 2D coordinate of a projection point projecting the j-th feature point in the SFM point cloud to the image coordinate system of the reference camera according to K, R, t and then transforming into the image coordinate system of the non-reference camera according to R_{cf} and t_{cf}.

Here F*₂ represents the distance error function between the SFM point cloud and the radar point cloud, see formula (27).

F*₂=F*_{2,1}+F*_{2,2} (27)

Here F*_{2,1} represents the distance error function from the feature point in the SFM point cloud to the straight line where the matched feature point in the radar point cloud is located, see formula (28).

$${F}_{2 , 1}^{*} = {\sum }_{J} {\sum }_{k ∈ K} {‖ {D}_{1} ( {R}_{cl}^{k} , {t}_{cl}^{k} , R , t , {X}_{h}^{j} , {X}_{{l}_{1 , 1}}^{k} , {X}_{{l}_{1 , 2}}^{k} ) ‖}_{{\sum }_{j , {l}_{1 , 1} , {l}_{1 , 2}}^{- 1}}^{2} \qquad ( 28 )$$

Here K represents a radar point cloud set, k represents the k-th radar point cloud, R_{cl}^{k} and t_{cl}^{k} represent a pose transformation relationship between the laser radar and the reference camera when the k-th radar point cloud is acquired, Xₕ^{j} represents a 3D coordinate of the j-th feature point in the SFM point cloud under the global coordinate system, Xₗ_{_{1,1}}^{k} and Xₗ_{_{1,2}}^{k} represent coordinates of two matched feature points matched with Xₕ^{j} in the k-th radar point cloud under the radar coordinate system, and may represent a straight line where the two matched feature points are located,

$${‖ ‖}_{{\sum }_{j , {l}_{1 , 1} , {l}_{1 , 2}}^{- 1}}^{2}$$

represents square of a P-norm,

$$P = {\sum }_{{\sum }_{j , {l}_{1 , 1} , {l}_{1 , 2}}^{- 1}}^{- 1} .$$

Here D₁(R_{cl}^{k},t_{cl}^{k},R,t,Xₕ^{j},Xₗ_{_{1,1}}^{k},Xₗ_{_{1,2}}^{k}) represents that the matched feature points in the radar point cloud and the feature points in the SFM point cloud are transformed into the same coordinate system (for example, the camera coordinate system of the camera), according to the pose transformation relationship between the laser radar and the reference camera and the coordinate transformation relationship between the camera coordinate system of the reference camera and the global coordinate system, by using formula (4) and formula (5), or by using formula (6). The vertical distance D₁ from the feature point in the SFM point cloud to the straight line where the matched feature point in the radar point cloud is located is determined in the same coordinate system by using formula (7) or (8).

Here F*_{2,2} represents the distance error function from the feature point in the SFM point cloud to the plane where the matched feature point in the radar point cloud is located, see formula (29).

$${F}_{2 , 2}^{*} = {\sum }_{J} {\sum }_{k ∈ K} {‖ {D}_{2} ( {R}_{cl}^{k} , {t}_{cl}^{k} , R , t , {X}_{h}^{j} , {X}_{{l}_{1 , 1}}^{k} , {X}_{{l}_{1 , 2}}^{k} , {X}_{{l}_{1 , 3}}^{k} ) ‖}_{{\sum }_{j , {l}_{1 , 1} , {l}_{1 , 2} , {l}_{1 , 3}}^{- 1}}^{2} \qquad ( 29 )$$

Here Xₗ_{_{1,1}}^{k}, Xₗ_{_{1,2}}^{k} and Xₗ_{_{1,3}}^{k} represent coordinates of three matched feature points matched with Xₕ^{j} in the k-th radar point cloud under the radar coordinate system, and may represent a plane where the three matched feature points are located,

$${‖ ‖}_{{\sum }_{j , {l}_{1 , 1} , {l}_{1 , 2} , {l}_{1 , 3}}^{- 1}}^{2}$$

represents square of a P-norm, P=Σ_{j,l}_{_{1,1}}_{,l}_{_{1,2}}_{,l}_{_{1,3}}.

Here D₂(R_{cl}^{k},t_{cl}^{k},R,t,Xₕ^{j},Xₗ_{_{1,1}}^{k},Xₗ_{_{1,2}}^{k},Xₗ_{_{1,3}}^{k}) represents that the matched feature points in the radar point cloud and the feature points in the SFM point cloud are transformed into the same coordinate system (for example, the camera coordinate system of the camera), according to the pose transformation relationship between the laser radar and the reference camera and the coordinate transformation relationship between the camera coordinate system of the reference camera and the global coordinate system, by using formula (4) and formula (5), or by using formula (6). The vertical distance D₂ from the feature point in the SFM point cloud to the plane where the matched feature point in the radar point cloud is located is determined in the same coordinate system by using formula (9) or (10).

Here F*₃ represents the distance error function between the radar point clouds of different frames, see formula (30).

F*₃=F*_{3,1}+F*_{3,2} (30)

Here F*_{3,1} represents the distance error function from the feature point in the radar point cloud of current frame to the straight line where the matched feature point in the radar point cloud of adjacent frame is located, see formula (31).

$${F}_{3 , 1}^{*} = {\sum }_{K} {\sum }_{u ∈ U} {‖ {D}_{1} ( {R}_{l}^{k} , {t}_{l}^{k} , {X}_{{l}_{0}}^{{k}_{0} , u} , {X}_{{l}_{1 , 1}}^{{k}_{1} , u} , {X}_{{l}_{1 , 2}}^{{k}_{1} , u} ) ‖}_{{\sum }_{u , {l}_{1 , 1} , {l}_{1 , 2}}^{- 1}}^{2} \qquad ( 31 )$$

Here U represents the number of feature points in any one of radar point clouds, u represents the u-th feature point in any one of radar point clouds, Rₗ^{k} and tₗ^{k} represent radar poses when the k-th radar point cloud is acquired, or may represent the k-th relative pose between radar point clouds of any two frames, k₀ represents the radar point cloud of current frame, k₁ represents the radar point cloud of adjacent frame, k₀ and k₁ ∈ k, Xₗ_{₀}^{k}^{₀}^{,u} represents a coordinate of the u-th feature point in the radar point cloud of current frame under the radar coordinate system, Xₗ_{_{1,1}}^{k}^{ₗ}^{,u} and Xₗ_{_{1,2}}^{k}^{₁}^{,u} represent two matched feature points matched with the feature point of current frame in the radar point cloud of adjacent frame, and may represent the straight line where the matched feature points are located,

$${‖ ‖}_{{\sum }_{u , {l}_{1 , 1} , {l}_{1 , 2}}^{- 1}}^{2}$$

represents square of a P-norm, and

$$P = {\sum }_{{\sum }_{u , {l}_{1 , 1} , {l}_{1 , 2}}^{- 1}}^{- 1} .$$

Here D₁(Rₗ^{k},tₗ^{k},Xₗ_{₀}^{k}^{₀}^{,u},Xₗ_{_{1,1}}^{k}^{₁}^{,u},Xₗ_{_{1,2}}^{k}^{₁}^{,u}) represents that the feature points of the radar point cloud of current frame and the radar point cloud of adjacent frame are transformed into the same coordinate system (for example, the global coordinate system), according to the radar pose when the radar point cloud of each frame is acquired or the relative pose between radar point clouds of any two frames. The vertical distance D₁ from the feature point in the radar point cloud of current frame to the straight line where the matched feature point in the radar point cloud of adjacent frame is located is determined in the same coordinate system by using formula (7) or (8).

Here F*_{3,2} represents the distance error function from the feature point in the radar point cloud of current frame to the plane where the feature point in the radar point cloud of adjacent frame is located, see formula (32).

$${F}_{3 , 2}^{*} = {\sum }_{K} {\sum }_{u ∈ U} {‖ {D}_{2} ( {R}_{l}^{k} , {t}_{l}^{k} , {X}_{{l}_{0}}^{{k}_{0} , u} , {X}_{{l}_{1 , 1}}^{{k}_{1} , u} , {X}_{{l}_{1 , 2}}^{{k}_{1} , u} , {X}_{{l}_{1 , 3}}^{{k}_{1} , u} ) ‖}_{{\sum }_{u , {l}_{1 , 1} , {l}_{1 , 2} , {l}_{1 , 3}}^{- 1}}^{2} \qquad ( 32 )$$

Here Xₗ_{_{1,1}}^{k}^{₁}^{,u}, Xₗ_{_{1,2}}^{k}^{₁}^{,u} and Xₗ_{_{1,3}}^{k}^{₁}^{,u} represent three matched feature points matched with the feature point of current frame in the radar point cloud of adjacent frame, and may represent the plane where the three matched feature points are located,

$${‖ ‖}_{{\sum }_{u , {l}_{1 , 1} , {l}_{1 , 2} , {l}_{1 , 3}}^{- 1}}^{2}$$

represents square of a P-norm, and

$$P = {\sum }_{{\sum }_{u , {l}_{1 , 1} , {l}_{1 , 2} , {l}_{1 , 3}}^{- 1}}^{- 1} .$$

Here D₂(Rₗ^{k},tₗ^{k},Xₗ_{₀}^{k}^{₀}^{,u},Xₗ_{_{1,1}}^{k}^{₁}^{,u},Xₗ_{_{1,2}}^{k}^{₁}^{,u},Xₗ_{_{1,3}}^{k}^{₁}^{,u}) represents that the feature points of the radar point cloud of current frame and the radar point cloud of adjacent frame are transformed into the same coordinate system (for example, the global coordinate system), according to the radar pose when the radar point cloud of each frame is acquired or the relative pose between radar point clouds of any two frames. The vertical distance D₂ from the feature point in the radar point cloud of current frame to the plane where the matched feature point in the radar point cloud of adjacent frame is located is determined in the same coordinate system by using formula (9) or (10).

It should be understood that the joint error function (23) includes the reprojection error, the distance error between the SFM point cloud and the radar point cloud, the distance error between the laser radar of different frames, and the optimization variable includes the SFM point cloud, internal camera parameters, the camera pose and the radar pose.

BA algorithm may be used for optimization to solve the minimum value of the joint error function, and the optimized SFM point cloud, internal camera parameters, the camera pose and the radar pose may be changed. Therefore, after the optimization is completed once, the joint optimization function may be constructed again according to the sensor calibration method by the newly generated SFM point cloud, internal camera parameters, the camera pose and the radar pose, for solving. The iterative process may be repeated many times until poses of all sensors no longer change (converge) or the number of iterations is satisfied, to obtain calibration results of the laser radar and the camera.

In a seventh operation, it is determined whether the number of iterations is satisfied or whether it is converged, and when the number of iterations is satisfied or it is converged, a calibration result of each sensor and a 3D map are obtained, the 3D map is a 3D virtual map obtained by fusing the optimized SFM point cloud and radar point cloud.

According to the embodiment of the disclosure, a unified calibration framework may be constructed to jointly calibrate multiple sensors. It is a fully automatic sensor calibration method, which may reduce calibration errors of multiple sensors introduced by a calibration object, and may meet the requirement of regular calibration.

According to an embodiment of the disclosure, it is applicable to joint calibration of multiple sensors in scenes such as UAV, a high-precision map construction, an automatic driving high-precision map construction, a large-scale scene 3D reconstruction based on images, or the like. Different number of sources and data of the same source are closely coupled and uniformly optimized by constructing the joint optimization function, to obtain an accurate calibration result, and it may also be directly used in image-laser joint calibration of a large-scale road.

According to the embodiment of the disclosure, a method for extracting features from an image sparse reconstruction point cloud of and a point cloud of a laser radar is proposed, it is proposed that information of the laser radar is included in a 3D reconstruction process of the image, and three types of constraints such as radar-radar, radar-camera and camera-camera are included in a unified optimization framework by constructing geometric constraints between the laser point and the image sparse reconstruction point.

It may be understood that the above method embodiments mentioned in the disclosure may be combined with each other without departing from their principle and logics, to form a combined embodiment, which is not elaborated in the disclosure due to limited space. It may be understood by those skilled in the art that specific execution orders of operations of the above methods described in detailed descriptions should be determined by their functions and possible intrinsic logics.

Furthermore, the disclosure further provides a sensor calibration apparatus, an electronic device, a computer-readable storage medium, and a program, all of which may implement any one of the sensor calibration methods provided in the disclosure, and corresponding technical solutions and descriptions may refer to corresponding recordation of the method and are not elaborated.

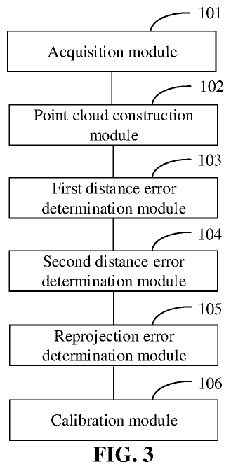

FIG. 3 shows a block diagram of a sensor calibration apparatus according to an embodiment of the disclosure. As shown in FIG. 3, the apparatus includes an acquisition module, a point cloud construction module, a first distance error determination module, a second distance error determination module, a reprojection error determination module, and a calibration module.

The acquisition module is configured to acquire, by an image sensor and a radar sensor disposed on an intelligent device, multiple scene images and multiple first point clouds of a target scene where the intelligent device is located, respectively. The point cloud construction module is configured to construct, according to the multiple scene images, a second point cloud of the target scene in a global coordinate system. The first distance error determination module is configured to determine, according to first feature point sets of the first point clouds and a second feature point set of the second point cloud, a first distance error between the image sensor and the radar sensor. The second distance error determination module is configured to determine, according to multiple first feature point sets, a second distance error of the radar sensor. The reprojection error determination module is configured to determine a reprojection error of the image sensor according to a first global position of the second feature point set in the global coordinate system and first image positions of pixel points corresponding to the second feature point set in the scene images. The calibration module is configured to calibrate the radar sensor and the image sensor according to the first distance error, the second distance error and the reprojection error, to obtain a first calibration result of the radar sensor and a second calibration result of the image sensor.

In a possible implementation, the apparatus may further include a first feature extraction module and a second feature extraction module. The first feature extraction module is configured to extract feature points from the multiple first point clouds, respectively, to determine a first feature point set of each of the multiple first point clouds. The second feature extraction module is configured to extract feature points from the second point cloud, to determine the second feature point set of the second point cloud. The first distance error determination module may include a first matching sub-module, a first sub-error determination sub-module and a first distance error determination sub-module. The first matching sub-module is configured to determine, for any one set of the first feature point sets, matched first feature point pairs according to distances between first feature points in the first feature point set and second feature points in the second feature point set, each of the first feature point pairs includes a first feature point and a second feature point. The first sub-error determination sub-module is configured to determine, according to multiple matched first feature point pairs, a first sub-error between the first feature point set and the second feature point set. The first distance error determination sub-module is configured to determine, according to multiple first sub-errors, the first distance error between the image sensor and the radar sensor.

In a possible implementation, the first feature extraction module may include a point cloud sequence determination sub-module, a first adjacent point determination sub-module, a curvature determination sub-module and a first feature point set determination sub-module. The point cloud sequence determination sub-module is configured to determine, for any one of the first point clouds, a point cloud sequence of the first point cloud according to a relative position of each of laser emission points of the radar sensor. The first adjacent point determination sub-module is configured to determine, according to the point cloud sequence of the first point cloud, multiple first adjacent points corresponding to any one of first data points in the first point cloud. The curvature determination sub-module is configured to determine, according to a coordinate of the first data point and coordinates of the multiple first adjacent points, a curvature corresponding to the first data point. The first feature point set determination sub-module is configured to determine, according to curvature of multiple first data points in the first point cloud, the first feature point set in the first point cloud.

In a possible implementation, the determining, according to curvature of the multiple first data points in the first point cloud, the first feature point set in the first point cloud may include the following operations. The multiple first data points are sorted according to the curvature of the multiple first data points, to obtain a sorting result. n first data points in the sorting result are selected as n edge points, in a descending order. Or, m first data points in the sorting result are selected as m plane points, in an ascending order. n and m are positive integers, and the first feature point set includes at least the edge points or the plane points.

In a possible implementation, the second feature extraction module may include a second adjacent point determination sub-module, a distance determination sub-module and a second feature point set determination sub-module. The second adjacent point determination sub-module is configured to determine, for any one of second data points in the second point cloud, multiple second adjacent points corresponding to the second data point from the second point cloud. The distance determination sub-module is configured to determine, according to a coordinate of the second data point and coordinates of the multiple second adjacent points, a distance between the second data point and each of the second adjacent points, respectively. The second feature point set determination sub-module is configured to determine the second data point as the second feature point in the second feature point set, in response to the distance between the second data point and each of the second adjacent points being smaller than a first distance threshold.

In a possible implementation, the second feature point set may include multiple second feature points, the apparatus may further include a feature point determination module, the feature point determination module is configured to determine at least edge points or plane points from the multiple second feature points. The determining at least edge points or plane points from the multiple second feature points may include the following operations. For any one of the second feature points, a covariance matrix of multiple second adjacent points corresponding to the second feature point is determined, and the covariance matrix is decomposed to obtain a multi-dimensional feature value. The second feature point is determined as the edge point, in response to a difference between any one-dimensional feature value and each-dimensional feature value of the multi-dimensional feature value exceeding a difference threshold.

In a possible implementation, the determining at least edge points or plane points from the multiple second feature points may further may include the following operations. For any one of the second feature points, a plane equation is fitted according to the multiple second adjacent points corresponding to the second feature point, and a normal vector of the plane equation is determined. The second feature point is determined as the plane point, in response to products of the multiple second adjacent points corresponding to the second feature point and the normal vector falling within a threshold range.

In a possible implementation, the determining, for any one set of the first feature point sets, matched first feature point pairs according to the distances between the first feature points in the first feature point set and the second feature points in the second feature point set may include the following operations. For any one set of the first feature point sets, distances between the first feature points in the first feature point set and the second feature points in the second feature point set is determined according to a pose transformation relationship between the radar sensor and the image sensor and a coordinate transformation relationship between a camera coordinate system of the image sensor and the global coordinate system. The first feature point and the second feature point between which the distance is smaller than a second distance threshold are determined as the matched first feature point pair.

In a possible implementation, the determining, for any one set of the first feature point sets, the distances between the first feature points in the first feature point set and the second feature points in the second feature point set according to the pose transformation relationship between the radar sensor and the image sensor and the coordinate transformation relationship between the camera coordinate system of the image sensor and the global coordinate system may include the following operations. For any one set of the first feature point sets, first positions of the first feature points in the first feature point set in the camera coordinate system is determined according to the pose transformation relationship between the radar sensor and the image sensor. Second positions of the second feature points in the second feature point set under the camera coordinate system is determined according to the coordinate transformation relationship between the camera coordinate system and the global coordinate system. The distances between the first feature points in the first feature point set and the second feature points in the second feature point set is determined according to the first position and the second position.

In a possible implementation, the determining, for any one set of the first feature point sets, the distances between the first feature points in the first feature point set and the second feature points in the second feature point set according to the pose transformation relationship between the radar sensor and the image sensor and the coordinate transformation relationship between the camera coordinate system of the image sensor and the global coordinate system may further include the following operations. For any one set of the first feature point sets, second global positions of the first feature points in the first feature point set in the global coordinate system is determined according to the pose transformation relationship between the radar sensor and the image sensor and the coordinate transformation relationship between the camera coordinate system and the global coordinate system. The distances between the first feature points in the first feature point set and the second feature points in the second feature point set is determined according to the second global positions and first global positions of the second feature points in the second feature point set.

In a possible implementation, the first feature point pairs may include at least an edge point pair or a plane point pair. The determining, according to the multiple matched first feature point pairs, the first sub-error between the first feature point set and the second feature point set may include the following operations. For any one of the first feature point pairs, a first vertical distance from a second feature point in the first feature point pair to a straight line where a first feature point in the first feature point pair is located, is determined in response to the first feature point pair being the edge point pair. A second vertical distance from a second feature point in the first feature point pair to a plane where a first feature point in the first feature point pair is located, is determined in response to the first feature point pair being the plane point pair. The first sub-error is determined according to at least multiple first vertical distances or multiple second vertical distances.

In a possible implementation, the second distance error determination module may include a second matching sub-module, a second sub-error determination sub-module and a second distance error determination sub-module. The second matching sub-module is configured to determine matched second feature point pairs according to distances between third feature points in a third feature point set and fourth feature points in a fourth feature point set, the third feature point set and the fourth feature point set are any two of the first feature point sets, and each of the second feature point pairs includes a third feature point and a fourth feature point. The second sub-error determination sub-module is configured to determine, according to multiple matched second feature point pairs, a second sub-error between the third feature point set and the fourth feature point set. The second distance error determination sub-module is configured to determine, according to multiple second sub-errors, the second distance error of the radar sensor.

In a possible implementation, the determining matched second feature point pairs according to the distances between the third feature points in the third feature point set and the fourth feature points in the fourth feature point set may include the following operations. The distances between the third feature points in the third feature point set and the fourth feature points in the fourth feature point set is determined according to a radar pose of the radar sensor acquiring each of the first point clouds. The third feature point and the fourth feature point between which the distance is smaller than a third distance threshold is determined as the matched second feature point pair.

In a possible implementation, the determining, according to the radar pose of the radar sensor acquiring each of the first point clouds, the distances between the third feature points in the third feature point set and the fourth feature points in the fourth feature point set may include the following operations. Third global positions of the third feature points in the third feature point set in the global coordinate system and fourth global positions of the fourth feature points in the fourth feature point set in the global coordinate system are determined according to the radar pose of the radar sensor acquiring each of the first point clouds. The distances between the third feature points in the third feature point set and the fourth feature points in the fourth feature point set is determined according to the third global position and the fourth global position.

In a possible implementation, the second feature point pairs may include at least an edge point pair or a plane point pair. The determining, according to the multiple matched second feature point pairs, the second sub-error between the third feature point set and the fourth feature point set may include the following operations. For any one of the second feature point pairs, a third vertical distance from a third feature point in the second feature point pair to a straight line where a fourth feature point in the second feature point pair is located, is determined in response to the second feature point pair being the edge point pair. A fourth vertical distance from a third feature point in the second feature point pair to a plane where a fourth feature point in the first feature point pair is located, is determined in response to the second feature point pair being the plane point pair. The second sub-error is determined according to at least multiple third vertical distances or multiple fourth vertical distances.

In a possible implementation, the reprojection error determination module may include an image position determination sub-module, a first reprojection sub-error determination sub-module and a first reprojection error determination sub-module. The image position determination sub-module is configured to for any one of the scene images, according to a first global position of any one of second feature points in the second feature point set and camera parameters of the image sensor, determine a second image position of the second feature point in the scene image. The first reprojection sub-error determination sub-module is configured to determine a reprojection sub-error corresponding to the scene image according to second image positions of multiple second feature points and first image positions of pixel points corresponding to the multiple second feature points in the scene image. The first reprojection error determination sub-module is configured to determine, according to reprojection sub-errors corresponding to the multiple scene images, the reprojection error of the image sensor.

In a possible implementation, the image sensor may include multiple image sensors including a reference image sensor and at least one non-reference image sensor, and the multiple scene images include multiple reference images acquired by the reference image sensor and multiple non-reference images acquired by the non-reference image sensor. The reprojection error determination module may include a non-reference image position determination sub-module, a second reprojection sub-error determination sub-module and a second reprojection error determination sub-module. The non-reference image position determination sub-module is configured to for any one of non-reference images, according to a first global position of any one of second feature points in the second feature point set, camera parameters of the reference image sensor and a pose transformation relationship between the non-reference image sensor and the reference image sensor, determine a third image position of the second feature point in the non-reference image. The second reprojection sub-error determination sub-module is configured to determine a reprojection sub-error corresponding to the non-reference image according to third image positions of multiple second feature points and fourth image positions of pixel points corresponding to the second feature points in the non-reference image. The second reprojection error determination sub-module is configured to determine, according to reprojection sub-errors corresponding to the multiple non-reference images, the reprojection error of the non-reference image sensor.

In a possible implementation, the calibration module may include an optimization sub-module and a calibration sub-module. The optimization sub-module is configured to optimize a radar pose of the radar sensor, camera parameters of the image sensor and the second feature point set according to the first distance error, the second distance error and the reprojection error. The calibration sub-module is configured to re-perform the sensor calibration method according to the optimized radar pose, optimized camera parameters and optimized second feature point set, until the radar pose of the radar sensor and the camera parameters of the image sensor are converged respectively, to obtain the first calibration result of the radar sensor and the second calibration result of the image sensor, the first calibration result includes the converged radar pose, and the second calibration result includes the converged camera parameters.

In a possible implementation, the intelligent device may include any one of an intelligent vehicle, an intelligent robot, or an intelligent robot arm; the radar sensor may include any one of a laser radar or a millimeter wave radar; the image sensor may include at least one of a monocular RGB camera, a binocular RGB camera, a TOF camera, or an infrared camera; and the camera parameters of the image sensor may include camera internal parameters and camera poses.

In the embodiment of the disclosure, the radar sensor and the image sensor may be calibrated automatically by using the first distance error between the image sensor and the radar sensor, the second distance error of the radar sensor, and the reprojection error of the image sensor, and an accuracy of the calibration result may be provided by using a combination of the first distance error, the second distance error and the reprojection error. Compared with a manner of calibrating by using a calibration object in the related art, the calibration process does not use the calibration object, has a simple operation, has a small calibration error, and may meet the requirement of regular calibration.

In some embodiments, the apparatus provided in the embodiments of the disclosure has functions or modules which may perform the methods described in the above method embodiments, and of which specific implementation may refer to the descriptions of the above method embodiments and is not elaborated here for simplicity.

An embodiment of the disclosure further proposes a computer-readable storage medium, having stored thereon computer program instructions which implement the above methods when executed by a processor. The computer-readable storage medium may be a volatile or non-volatile computer-readable storage medium.

An embodiment of the disclosure further proposes an electronic device, including a processor and a memory configured to store instructions executable by the processor, the processor is configured to call the instructions stored in the memory, to perform the above methods.

An embodiment of the disclosure further provides a computer program product including computer-readable codes, or a non-volatile computer-readable storage medium carrying the computer-readable codes, which enable a processor of an electronic device to perform the above methods, when the computer-readable codes are running in the processor of the electronic device.

An embodiment of the disclosure further provides a computer program including computer-readable codes, which enable a processor of an electronic device to perform the above methods, when the computer-readable codes are running in the electronic device.

The electronic device may be provided as an intelligent device, a terminal device, a server, or another form of device.

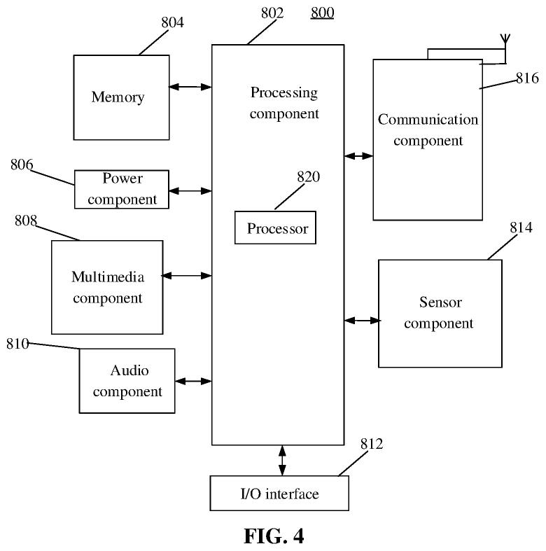

FIG. 4 shows a block diagram of an electronic device 800 according to an embodiment of the disclosure. For example, the electronic device 800 may be an intelligent device, or a terminal device such as a mobile phone, a computer, a digital broadcast terminal, a messaging device, a game console, a tablet device, a medical device, an exercise device, PDA, or the like.

Referring to FIG. 4, the electronic device 800 may include one or more of the following components: a processing component 802, a memory 804, a power component 806, a multimedia component 808, an audio component 810, an input/output (I/O) interface 812, a sensor component 814, and a communication component 816.

The processing component 802 usually controls overall operations of the electronic device 800, such as the operations associated with display, telephone call, data communication, camera operation, and recording operation. The processing component 802 may include one or more processors 820 to execute instructions to perform all or part of the operations in the above methods. Furthermore, the processing component 802 may include one or more modules to facilitate the interaction between the processing component 802 and other components. For example, the processing component 802 may include a multimedia module to facilitate the interaction between the multimedia component 808 and the processing component 802.

The memory 804 is configured to store various types of data to support the operations of the electronic device 800. Examples of such data include instructions for any applications or methods operated on the electronic device 800, contact data, phonebook data, messages, pictures, video, or the like. The memory 804 may be implemented by any type of volatile or non-volatile memory devices, or a combination thereof, such as a static random-access memory (SRAM), an electrically erasable programmable read only memory (EEPROM), an erasable programmable read only memory (EPROM), a programmable read only memory (PROM), a read only memory (ROM), a magnetic memory, a flash memory, a magnetic disk, or an optical disk.

The power component 806 provides power to various components of the electronic device 800. The power component 806 may include a power management system, one or more power sources, and other components associated with the generation, management and distribution of power in the electronic device 800.

The multimedia component 808 includes a screen providing an output interface between the electronic device 800 and a user. In some embodiments, the screen may include a liquid crystal display (LCD) and a touch panel (TP). When the screen includes the TP, the screen may be implemented as a touch screen to receive input signals from the user. The TP includes one or more touch sensors to sense touches, swipes, and gestures on the TP. The touch sensors may not only sense a boundary of a touch or swipe action, but also sense a time period and a pressure associated with the touch or swipe action. In some embodiments, the multimedia component 808 includes a front camera and/or a rear camera. The front camera and/or the rear camera may receive external multimedia data when the electronic device 800 is in an operation mode, such as a photographing mode or a video mode. Each of the front camera and the rear camera may be a fixed optical lens system or have a focal length and optical zoom capability.

The audio component 810 is configured to output and/or input audio signals. For example, the audio component 810 includes a microphone (MIC) configured to receive an external audio signal when the electronic device 800 is in an operation mode, such as a call mode, a recording mode and a voice recognition mode. The received audio signal may be further stored in the memory 804 or transmitted via the communication component 816. In some embodiments of the disclosure, the audio component 810 further includes a speaker to output audio signals.

The I/O interface 812 provides an interface between the processing component 802 and a peripheral interface module, which may be a keyboard, a click wheel, a button, or the like. The button may include, but is not limited to, a home button, a volume button, a starting button, and a locking button.

The sensor component 814 includes one or more sensors to provide status assessments of various aspects of the electronic device 800. For example, the sensor component 814 may detect an open/closed status of the electronic device 800, relative positioning of components, e.g., the display and the keypad, of the electronic device 800. The sensor component 814 may also detect change of position of the electronic device 800 or a component of the electronic device 800, presence or absence of the user contacting with the electronic device 800, an orientation or acceleration/deceleration of the electronic device 800, and change of temperature of the electronic device 800. The sensor component 814 may include a proximity sensor configured to detect the presence of nearby objects without any physical contact. The sensor component 814 may also include a light sensor, such as a complementary metal oxide semiconductor (CMOS) or charge-coupled device (CCD) image sensor, used in imaging applications. In some embodiments, the sensor component 814 may also include an acceleration sensor, a gyroscope sensor, a magnetic sensor, a pressure sensor, or a temperature sensor.

The communication component 816 is configured to facilitate wired or wireless communication between the electronic device 800 and other devices. The electronic device 800 may access a wireless network based on a communication standard, such as Wi-Fi, Second generation (2G) or Third generation (3G) mobile communication technology, or a combination thereof. In an exemplary embodiment, the communication component 816 receives a broadcast signal or broadcast associated information from an external broadcast management system via a broadcast channel. In an exemplary embodiment, the communication component 816 also includes a near field communication (NFC) module to facilitate short-range communication. For example, the NFC module may be implemented based on a radio frequency identification (RFID) technology, an infrared data association (IrDA) technology, an ultra wide band (UWB) technology, a Bluetooth (BT) technology, and other technologies.

In an exemplary embodiment, the electronic device 800 may be implemented with one or more application specific integrated circuits (ASICs), digital signal processors (DSPs), digital signal processor devices (DSPDs), programmable logic devices (PLDs), field programmable gate arrays (FPGAs), controllers, micro-controllers, microprocessors, or other electronic components, to perform the above methods.

In an exemplary embodiment, there is also provided a non-volatile computer-readable storage medium, such as the memory 804 including computer program instructions which are executable by the processor 820 of the electronic device 800 to perform the above methods.

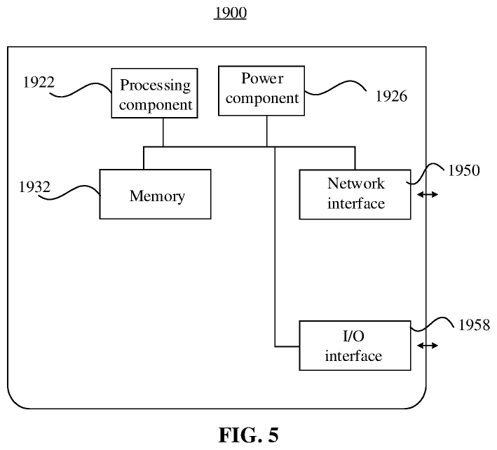

FIG. 5 shows a block diagram of an electronic device 1900 according to an embodiment of the disclosure. For example, the electronic device 1900 may be provided as a server. Referring to FIG. 5, the electronic device 1900 includes a processing component 1922 which may include one or more processors, and memory resources represented by a memory 1932 and storing instructions, such as applications, executable by the processing component 1922. The applications stored in the memory 1932 may include one or more modules each of which corresponding to a set of instructions. Furthermore, the processing component 1922 is configured to execute instructions to perform the above methods.

The electronic device 1900 may further include a power component 1926 configured to perform power management of the electronic device 1900, a wired or wireless network interface 1950 configured to connect the electronic device 1900 to a network, and an I/O interface 1958. The electronic device 1900 may operate based on an operating system stored in the memory 1932, such as a server operating system (Windows Server™) from Microsoft, an operating system (Mac OS X™) based on graphical user interface released by Apple, a multi-user multi-process computer operating system (Unix™), a Unix-like operating system (Linux™) based on free and open original codes, a Unix-like operating system (FreeBSD™) based on open original codes, or the like.

In an exemplary embodiment, there is also provided a non-volatile computer-readable storage medium, such as the memory 1932 including computer program instructions which are executable by the processing component 1922 of the electronic device 1900 to perform the above methods.

The disclosure may be a system, a method, and/or a computer program product. The computer program product may include a computer-readable storage medium having computer-readable program instructions thereon to allow a processor to implement various aspects of the disclosure.

The computer-readable storage medium may be a tangible device that may hold and store instructions used by an instruction execution device. For example, the computer-readable storage medium may be (but is not limited to) an electrical storage device, a magnetic storage device, an optical storage device, an electromagnetic storage device, a semiconductor storage device, or any suitable combination of the above devices. More specific examples (non-exhaustive lists) of the computer-readable storage medium include: a portable computer disk, a hard disk, a random access memory (RAM), a ROM, an EPROM or a flash memory, an SRAM, a portable compact disk-read only memory (CD-ROM), a digital video disk (DVD), a memory stick, a floppy disk, a mechanical encoding device, e.g., a punch card or in-groove bump structure on which instructions are stored, and any suitable combination of the above memories. The computer-readable storage medium as used here is not construed as an instantaneous signal itself, such as a radio wave or other freely propagating electromagnetic wave, an electromagnetic wave propagating through a waveguide or other transmission medium (e.g., an optical pulse through a fiber optic cable), or an electrical signal transmitted through a wire.

The computer-readable program instructions described here may be downloaded from a computer-readable storage medium to various computing/processing devices, or downloaded to an external computer or external storage device via a network, such as Internet, a local area network (LAN), a wide area network (WAN) and/or a wireless network. The network may include copper transmission cables, fiber optic transmission, wireless transmission, routers, firewalls, switches, gateway computers, and/or edge servers. A network adapter card or network interface in each computing/processing device receives computer-readable program instructions from the network and forwards the computer-readable program instructions to be stored in a computer-readable storage medium in a respective computing/processing device.

The computer program instructions performing the operations of the disclosure may be assembly instructions, industry standard architecture (ISA) instructions, machine instructions, machine-related instructions, microcode, firmware instructions, status setting data, or source or object codes written in any combination of one or more programming languages, including object-oriented programming languages such as Smalltalk, C++, or the like, and conventional procedural programming languages such as “C” language or similar programming languages. The computer-readable program instructions may be executed entirely on a user computer, executed partly on the user computer, executed as a separate software package, executed partly on the user computer and partly on a remote computer, or executed entirely on the remote computer or server. In case of the remote computer involved, the remote computer may be connected to the user computer through any kind of networks including a LAN or a WAN, or may be connected to an external computer (e.g., connected through the Internet using an Internet service provider). In some embodiments, an electronic circuit may execute the computer-readable program instructions by personalizing the electronic circuit, such as a programmable logic circuit, a FPGA or a programmable logic array (PLA), with status information of the computer-readable program instructions, so as to implement various aspects of the disclosure.

According to the embodiments of the disclosure, the radar sensor and the image sensor may be calibrated automatically by using the first distance error between the image sensor and the radar sensor, the second distance error of the radar sensor, and the reprojection error of the image sensor, and an accuracy of the calibration result may be provided by using a combination of the first distance error, the second distance error and the reprojection error. Compared with a manner of calibrating by using a calibration object in the related art, the calibration process does not use the calibration object, has a simple operation, has a small calibration error, and may meet the requirement of regular calibration.

Various aspects of the disclosure are described here with reference to flowcharts and/or block diagrams of methods, apparatus (systems) and computer program products according to the embodiments of the disclosure. It should be understood that each block of the flowcharts and/or block diagrams, and combination of blocks of the flowcharts and/or block diagrams, may be implemented by computer-readable program instructions.

These computer-readable program instructions may be provided to a processor of a general purpose computer, a special purpose computer, or other programmable data processing apparatuses to produce a machine, such that when executed by the processor of the computer or other programmable data processing apparatuses, the instructions produce an apparatus for implementing functions/actions specified in one or more blocks of the flowchart and/or block diagram. The computer-readable program instructions may also be stored in a computer-readable storage medium, these instructions allow a computer, a programmable data processing apparatus, and/or other devices to operate in a specific manner, such that the computer-readable medium having stored thereon instructions includes an article of manufacture, which includes instructions implementing various aspects of the functions/actions specified in one or more blocks of the flowchart and/or block diagram.

Computer-readable program instructions may also be loaded onto a computer, other programmable data processing apparatuses or other devices, such that a series of operational steps are performed on the computer, other programmable data processing apparatuses or other devices to produce a computer-implemented process, so that the instructions executed on the computer, other programmable data processing apparatuses or other devices implement the functions/actions specified in one or more blocks of the flowcharts and/or block diagrams.

The flowcharts and block diagrams in the drawings show architectures, functions and operations of possible implementations of the system, method and computer program product according to the embodiments of the disclosure. In this regard, each block of the flowchart or block diagram may represent a module, a program segment or part of an instruction, which contains one or more executable instructions for implementing a specified logical function. In some alternative implementations, the functions noted in the blocks may also occur in an order different from that noted in the drawings. For example, two successive blocks may actually be executed in parallel substantially, and sometimes they may be executed in a reverse order, depending on the functions involved. It should also be noted that each block of the block diagram and/or flowchart, and combination of blocks of the block diagram and/or flowchart, may be implemented with a dedicated hardware-based system performing specified functions or actions, or may be implemented with a combination of the dedicated hardware and computer instructions.

Specifically, the computer program product may be implemented by hardware, software, or a combination thereof. In an alternative embodiment, the computer program product is embodied as a computer storage medium, and in another alternative embodiment, the computer program product is embodied as a software product, such as a software development package (SDK), or the like.

The embodiments of the disclosure are described as above, the above descriptions are exemplary, rather than exhaustive, and are not limited to the disclosed embodiments, either. Many modifications and variations will be apparent to those of ordinary skill in the art without departing from the scopes and spirits of the illustrated embodiments. The choice of terms as used here is intended to best explain the principles of the embodiments, practical applications, or improvements to technologies available in the market, or to enable other of ordinary skill in the art to understand the embodiments as disclosed here.

1. A sensor calibration method, comprising:
acquiring, by an image sensor and a radar sensor disposed on an intelligent device, a plurality of scene images and a plurality of first point clouds of a target scene where the intelligent device is located, respectively;
constructing, according to the plurality of scene images, a second point cloud of the target scene in a global coordinate system;
determining, according to first feature point sets of the first point clouds and a second feature point set of the second point cloud, a first distance error between the image sensor and the radar sensor;
determining, according to a plurality of first feature point sets, a second distance error of the radar sensor;
determining a reprojection error of the image sensor according to a first global position of the second feature point set in the global coordinate system and first image positions of pixel points corresponding to the second feature point set in the scene images; and
calibrating the radar sensor and the image sensor according to the first distance error, the second distance error and the reprojection error, to obtain a first calibration result of the radar sensor and a second calibration result of the image sensor.

2. The method of claim 1, further comprising:
extracting feature points from the plurality of first point clouds, respectively, to determine a first feature point set of each of the plurality of first point clouds; and
extracting feature points from the second point cloud, to determine the second feature point set of the second point cloud,
wherein the determining, according to first feature point sets of the first point clouds and the second feature point set of the second point cloud, the first distance error between the image sensor and the radar sensor comprises:
determining, for any one set of the first feature point sets, matched first feature point pairs according to distances between first feature points in the first feature point set and second feature points in the second feature point set, each of the first feature point pairs comprising a first feature point and a second feature point;
determining, according to a plurality of matched first feature point pairs, a first sub-error between the first feature point set and the second feature point set; and
determining, according to a plurality of first sub-errors, the first distance error between the image sensor and the radar sensor.

3. The method of claim 2, wherein the extracting feature points from the plurality of first point clouds, respectively, to determine the first feature point set of each of the plurality of first point clouds comprises:
determining, for any one of the first point clouds, a point cloud sequence of the first point cloud according to a relative position of at least one laser emission point of the radar sensor;
determining, according to the point cloud sequence of the first point cloud, a plurality of first adjacent points corresponding to any one of first data points in the first point cloud;
determining, according to a coordinate of the first data point and coordinates of the plurality of first adjacent points, a curvature corresponding to the first data point; and
determining, according to curvature of a plurality of first data points in the first point cloud, the first feature point set in the first point cloud.

4. The method of claim 3, wherein the determining, according to curvature of the plurality of first data points in the first point cloud, the first feature point set in the first point cloud comprises:
sorting the plurality of first data points according to the curvature of the plurality of first data points, to obtain a sorting result;
selecting, in a descending order, n first data points in the sorting result as n edge points; and/or,
selecting, in an ascending order, m first data points in the sorting result as m plane points,
wherein n and m are positive integers, and the first feature point set comprises at least the edge points or the plane points.

5. The method of claim 2, wherein the extracting feature points from the second point cloud, to determine the second feature point set of the second point cloud comprises:
determining, for any one of second data points in the second point cloud, a plurality of second adjacent points corresponding to the second data point from the second point cloud;
determining, according to a coordinate of the second data point and coordinates of the plurality of second adjacent points, a distance between the second data point and at least one of the second adjacent points, respectively; and
determining the second data point as the second feature point in the second feature point set, in response to the distance between the second data point and at least one of the second adjacent points being smaller than a first distance threshold.

6. The method of claim 5, wherein the second feature point set comprises a plurality of second feature points, the method further comprising: determining at least edge points or plane points from the plurality of second feature points,
wherein the determining at least edge points or plane points from the plurality of second feature points comprises:
determining, for any one of the second feature points, a covariance matrix of a plurality of second adjacent points corresponding to the second feature point, and decomposing the covariance matrix to obtain a multi-dimensional feature value; and
determining the second feature point as the edge point, in response to a difference between any one-dimensional feature value of the multi-dimensional feature values and at least one-dimensional feature value exceeding a difference threshold.

7. The method of claim 6, wherein the determining at least edge points or plane points from the plurality of second feature points further comprises:
fitting, for any one of the second feature points, a plane equation according to the plurality of second adjacent points corresponding to the second feature point, and determining a normal vector of the plane equation; and
determining the second feature point as the plane point, in response to products of the plurality of second adjacent points corresponding to the second feature point and the normal vector falling within a threshold range.

8. The method of claim 2, wherein the determining, for any one set of the first feature point sets, matched first feature point pairs according to the distances between the first feature points in the first feature point set and the second feature points in the second feature point set comprises:
determining, for any one set of the first feature point sets, distances between the first feature points in the first feature point set and the second feature points in the second feature point set according to a pose transformation relationship between the radar sensor and the image sensor and a coordinate transformation relationship between a camera coordinate system of the image sensor and the global coordinate system; and
determining the first feature point and the second feature point between which the distance is smaller than a second distance threshold as the matched first feature point pair.

9. The method of claim 8, wherein the determining, for any one set of the first feature point sets, the distances between the first feature points in the first feature point set and the second feature points in the second feature point set according to the pose transformation relationship between the radar sensor and the image sensor and the coordinate transformation relationship between the camera coordinate system of the image sensor and the global coordinate system comprises:
determining, for any one set of the first feature point sets, first positions of the first feature points in the first feature point set in the camera coordinate system according to the pose transformation relationship between the radar sensor and the image sensor;
determining, according to the coordinate transformation relationship between the camera coordinate system and the global coordinate system, second positions of the second feature points in the second feature point set under the camera coordinate system; and
determining, according to the first position and the second position, the distances between the first feature points in the first feature point set and the second feature points in the second feature point set.

10. The method of claim 8, wherein the determining, for any one set of the first feature point sets, the distances between the first feature points in the first feature point set and the second feature points in the second feature point set according to the pose transformation relationship between the radar sensor and the image sensor and the coordinate transformation relationship between the camera coordinate system of the image sensor and the global coordinate system further comprises:
determining, for any one set of the first feature point sets, second global positions of the first feature points in the first feature point set in the global coordinate system according to the pose transformation relationship between the radar sensor and the image sensor and the coordinate transformation relationship between the camera coordinate system and the global coordinate system; and
determining, according to the second global positions and first global positions of the second feature points in the second feature point set, the distances between the first feature points in the first feature point set and the second feature points in the second feature point set.

11. The method of claim 2, wherein the first feature point pairs comprise at least an edge point pair or a plane point pair,
wherein the determining, according to the plurality of matched first feature point pairs, the first sub-error between the first feature point set and the second feature point set comprises:
determining, for any one of the first feature point pairs, a first vertical distance from a second feature point in the first feature point pair to a straight line where a first feature point in the first feature point pair is located, in response to the first feature point pair being the edge point pair;
determining a second vertical distance from a second feature point in the first feature point pair to a plane where a first feature point in the first feature point pair is located, in response to the first feature point pair being the plane point pair; and
determining the first sub-error according to at least a plurality of first vertical distances or a plurality of second vertical distances.

12. The method of claim 1, wherein the determining, according to the plurality of first feature point sets, the second distance error of the radar sensor comprises:
determining matched second feature point pairs according to distances between third feature points in a third feature point set and fourth feature points in a fourth feature point set, the third feature point set and the fourth feature point set being any two of the first feature point sets, and each of the second feature point pairs comprising a third feature point and a fourth feature point;
determining, according to a plurality of matched second feature point pairs, a second sub-error between the third feature point set and the fourth feature point set; and
determining, according to a plurality of second sub-errors, the second distance error of the radar sensor.

13. The method of claim 12, wherein the determining matched second feature point pairs according to the distances between the third feature points in the third feature point set and the fourth feature points in the fourth feature point set comprises:
determining, according to a radar pose of the radar sensor when acquiring at least one of the first point clouds, the distances between the third feature points in the third feature point set and the fourth feature points in the fourth feature point set; and
determining the third feature point and the fourth feature point between which the distance is smaller than a third distance threshold as the matched second feature point pair.

14. The method of claim 13, wherein the determining, according to the radar pose of the radar sensor when acquiring at least one of the first point clouds, the distances between the third feature points in the third feature point set and the fourth feature points in the fourth feature point set comprises:
determining, according to the radar pose of the radar sensor when acquiring at least one of the first point clouds, third global positions of the third feature points in the third feature point set in the global coordinate system and fourth global positions of the fourth feature points in the fourth feature point set in the global coordinate system; and
determining, according to the third global position and the fourth global position, the distances between the third feature points in the third feature point set and the fourth feature points in the fourth feature point set.

15. The method of claim 12, wherein the second feature point pairs comprise at least an edge point pair or a plane point pair,
wherein the determining, according to the plurality of matched second feature point pairs, the second sub-error between the third feature point set and the fourth feature point set comprises:
determining, for any one of the second feature point pairs, a third vertical distance from a third feature point in the second feature point pair to a straight line where a fourth feature point in the second feature point pair is located, in response to the second feature point pair being the edge point pair;
determining a fourth vertical distance from a third feature point in the second feature point pair to a plane where a fourth feature point in a first feature point pair is located, in response to the second feature point pair being the plane point pair; and
determining the second sub-error according to at least a plurality of third vertical distances or a plurality of fourth vertical distances.

16. The method of claim 1, wherein the determining the reprojection error of the image sensor according to the first global position of the second feature point set in the global coordinate system and the first image positions of pixel points corresponding to the second feature point set in the plurality of scene images comprises:
for any one of the scene images, according to a first global position of any one of second feature points in the second feature point set and camera parameters of the image sensor, determining a second image position of the second feature point in the scene image;
determining a reprojection sub-error corresponding to the scene image according to second image positions of a plurality of second feature points and first image positions of pixel points corresponding to the plurality of second feature points in the scene image; and
determining, according to reprojection sub-errors corresponding to the plurality of scene images, the reprojection error of the image sensor.

17. The method of claim 1, wherein the image sensor comprises a plurality of image sensors comprising a reference image sensor and at least one non-reference image sensor, and the plurality of scene images comprise a plurality of reference images acquired by the reference image sensor and a plurality of non-reference images acquired by the non-reference image sensor,
wherein the determining the reprojection error of the image sensor according to the first global position of the second feature point set in the global coordinate system and the first image positions of pixel points corresponding to the second feature point set in the plurality of scene images comprises:
for any one of non-reference images, according to a first global position of any one of second feature points in the second feature point set, camera parameters of the reference image sensor and a pose transformation relationship between the non-reference image sensor and the reference image sensor, determining a third image position of the second feature point in the non-reference image;
determining a reprojection sub-error corresponding to the non-reference image according to third image positions of a plurality of second feature points and fourth image positions of pixel points corresponding to the second feature points in the non-reference image; and
determining, according to reprojection sub-errors corresponding to the plurality of non-reference images, the reprojection error of the non-reference image sensor.

18. The method of claim 1, wherein the calibrating the radar sensor and the image sensor according to the first distance error, the second distance error and the reprojection error, to obtain the first calibration result of the radar sensor and the second calibration result of the image sensor comprises:
optimizing a radar pose of the radar sensor, camera parameters of the image sensor and the second feature point set according to the first distance error, the second distance error and the reprojection error; and
re-performing the sensor calibration method according to the optimized radar pose, optimized camera parameters and optimized second feature point set, until the radar pose of the radar sensor and the camera parameters of the image sensor are converged respectively, to obtain the first calibration result of the radar sensor and the second calibration result of the image sensor, the first calibration result comprising the converged radar pose, and the second calibration result comprising the converged camera parameters,
wherein the intelligent device comprises any one of an intelligent vehicle, an intelligent robot, or an intelligent robot arm; the radar sensor comprises any one of a laser radar or a millimeter wave radar; the image sensor comprises at least one of a monocular Red-Green-Blue (RGB) camera, a binocular RGB camera, a time-of-flight (TOF) camera, or an infrared camera; and the camera parameters of the image sensor comprise camera internal parameters and camera poses.

19. A sensor calibration apparatus, comprising:
a processor; and
a memory configured to store instructions executable by the processor,
wherein the processor is configured to call the instructions stored in the memory, to perform operations of:
acquiring, by an image sensor and a radar sensor disposed on an intelligent device, a plurality of scene images and a plurality of first point clouds of a target scene where the intelligent device is located, respectively;
constructing, according to the plurality of scene images, a second point cloud of the target scene in a global coordinate system;
determining, according to first feature point sets of the first point clouds and a second feature point set of the second point cloud, a first distance error between the image sensor and the radar sensor;
a second distance error determination module configured to determine, according to a plurality of first feature point sets, a second distance error of the radar sensor;
determining a reprojection error of the image sensor according to a first global position of the second feature point set in the global coordinate system and first image positions of pixel points corresponding to the second feature point set in the scene images; and
calibrating the radar sensor and the image sensor according to the first distance error, the second distance error and the reprojection error, to obtain a first calibration result of the radar sensor and a second calibration result of the image sensor.

20. A computer-readable storage medium having stored thereon computer program instructions that when executed by a processor, implement a sensor calibration method, the method comprising:
acquiring, by an image sensor and a radar sensor disposed on an intelligent device, a plurality of scene images and a plurality of first point clouds of a target scene where the intelligent device is located, respectively;
constructing, according to the plurality of scene images, a second point cloud of the target scene in a global coordinate system;
determining, according to first feature point sets of the first point clouds and a second feature point set of the second point cloud, a first distance error between the image sensor and the radar sensor;
determining, according to a plurality of first feature point sets, a second distance error of the radar sensor;
determining a reprojection error of the image sensor according to a first global position of the second feature point set in the global coordinate system and first image positions of pixel points corresponding to the second feature point set in the scene images; and
calibrating the radar sensor and the image sensor according to the first distance error, the second distance error and the reprojection error, to obtain a first calibration result of the radar sensor and a second calibration result of the image sensor.
